(19) United States
(12) Patent Application Publication
(10) Pub. No.: US 2026/0350571 A1
(43) Pub. Date: Nov. 5, 2026

(54) DYNAMIC MICRO-APPLICATIONS ARCHITECTURE FOR ROLE-BASED INTERFACE GENERATION

(71) Applicant: RENT-A-CENTER WEST, INC., Plano, TX (US)

(72) Inventors: Pranav SHARMA, Plano, TX (US); Melody M. CASSEL, Pottsboro, TX (US)

(73) Assignee: RENT-A-CENTER WEST, INC., Plano, TX (US)

(21) Appl. No.: 19/349,791

(22) Filed: Oct. 3, 2025

Related U.S. Application Data
(63) Continuation-in-part of application No. 19/196,202, filed on May 1, 2025, now abandoned.

(51) Int. Cl. G06Q 20/20

(52) U.S. Cl. CPC G06Q 20/20

(57) ABSTRACT

A dynamic micro-applications architecture for a lease-to-own transaction point-of-sale system facilitates the dynamic generation of different user interfaces on an administrator client device, a retailer client device, or a customer client device, based on roles or permissions of an accessing user. Different micro-applications that provide different lease-to-own transaction management features, such as customer verification or price or inventory management, are dynamically assembled client-side after a time of user sign-in, with micro-applications selected based on role or permissions of the signing-in user. Based on the architecture generated by the dynamic assembly of micro-applications, a signing-in user accessing a point-of-sale system URL that is general to all users is presented with a customized interface tailored to the role or permissions of the signing-in user. A communication backbone facilitates communications between different micro-applications. An event stream maintains consistent data views between different interface instances.

### CROSS-REFERENCE TO RELATED APPLICATIONS

This application claims the benefit of U.S. Nonprovisional Patent Application No. 19/196,202, filed on May. 1, 2025, the content of which is incorporated by reference.

### BACKGROUND

A lease-to-own transaction for personal property, such as furniture, household appliances, electronics or other durable goods, allows a customer to lease an item on a short-term, renewable basis, with various options, but not the obligation, to acquire ownership if elected by the customer. Lease-to-own is offered by leasing companies to consumers through a variety of distribution channels, including in-store and online through third party retailers, enabling consumers who may not have sufficient credit or savings or who otherwise seek the optionality of a lease-to-own transaction to access these goods on flexible terms with no long-term obligation. The customer typically makes optional renewal payments on a weekly, biweekly or monthly basis and can, as provided by their lease agreements, elect to renew the lease for a specified number of lease terms to ultimately acquire ownership, exercise an early purchase option, terminate the transaction or reinstate their lease following termination.

Technological systems to enable such transactions typically include combination of e-commerce and physical or online retail components to enable steps of the workflow: pre-approval of the transaction involving the physical products and the physical retail store; hardware and software components for facilitating interactions between the customer, physical retail store; and online retail platforms to facilitate completion of transactions via a flexible payment option at checkout.

Improved system and methods are needed for dynamic user interfaces for providing improved management of product leasing information in leasing systems across different client devices.

### BRIEF SUMMARY

The present disclosure provides, in an embodiment, a computer-implemented method for building instances of a dynamic point-of-sale system user interface for enabling management of product leasing information on different client devices. The method can include receiving, by a first server, from a first client device accessing the first server via a first uniform resource locator (URL), a login confirmation for a first user account. The method can further include determining a first user access control comprising at least one user role or user permissions associated with the first user account. The method can further include selecting a first set of micro-applications permitted for the first user account based on the first user access control. The first set of micro-applications can be selected from a plurality of micro-applications each having a product leasing information management feature including at least one of customer verification or inventory price management. The method can further include determining first scripting code configured to command the first client device to access at least one micro-application of the first set of micro-applications via a second URL from a second server. The method can further include serving, from the first server, the first scripting code to the first client device. The first scripting code, when executed on the first client device, causes the first client device to assemble a first instance of the dynamic point-of-sale system user interface including the first set of micro-applications. The first client device is configured to render and display the first instance of the dynamic point-of-sale system user interface to a display of the first client device.

The method can further include receiving, by the first server, from a second client device accessing the first server via the first URL, a login confirmation for a second user account. The method can further include determining a second user access control comprising at least one user role or user permissions associated with the second user account, wherein the second user access control is different from the first user access control. The method can further include selecting a second set of micro-applications permitted for the second user account based on the second user access control. The second set of one micro-applications can be selected from the plurality of micro-applications. The second set of micro-applications is different from the first set of micro-applications. The method can further include determining second scripting code configured to command the second client device to access at least one micro-application of the second set of micro-applications via a third URL from the second server or a third server. The method can further include serving, from the first server, the second scripting code to the second client device. The second scripting code, when executed on the second client device, causes the second client device to assemble a second instance of the dynamic point-of-sale system user interface including the second set of micro-applications. The second client device is configured to render and display the second instance of the dynamic point-of-sale system user interface to a display of the second client device.

System, device, and computer program product embodiments are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### BRIEF DESCRIPTION OF THE DRAWINGS

The accompanying drawings are incorporated herein and form a part of the specification.

FIG. 1A is a block diagram of an example system for facilitating retail transaction workflows, according to an embodiment.

FIG. 1B is a sequence diagram illustrating example interactions between different devices to generate a customized point-of-sale system comprising one or more micro-applications, according to an embodiment.

FIGS. 2A-2I and 2K-2T are illustrations of example user interface views of a point-of-sale system for facilitating retail transaction workflows, as presented to a retailer user or backend administrator user, according to an embodiment.

FIG. 2J is an illustration of an example spreadsheet used in conjunction with the point-of-sale system illustrated in FIGS. 2A-2I and 2K-2T.

FIG. 3A is an illustration of an example text messaging interface.

FIGS. 3B-3N are illustrations of example user interface views of a point-of-sale system for facilitating retail transaction workflows, as presented to a customer user, according to an embodiment.

FIGS. 4A and 4B are illustrations of example user interface views of a point-of-sale system for facilitating retail transaction workflows, as presented to a retailer user or backend administrator user, according to an embodiment.

FIGS. 5A-5F illustrate a system flowchart showing an example pricing services ensemble for automatically updating pricing of retail products, as may be viewable and editable in a point-of-sale system.

FIG. 6 is a flowchart illustrating a method for building instances of a dynamic point-of-sale system user interface for enabling management of product leasing information on different client devices.

FIG. 7 is a block diagram of an example computer system useful for implementing various aspects of this disclosure.

In the drawings, like reference numbers generally indicate identical or similar elements. Additionally, generally, the left-most digit(s) of a reference number identifies the drawing in which the reference number first appears.

### DETAILED DESCRIPTION

The present application describes an advanced point-of-sale system that includes features to manage an ecosystem of lease-to-own services usable by users having multiple different user access controls (e.g., user roles and/or user permissions), e.g., including by a customer user, a retailer user, and a backend administrator user. The point-of-sale system can be operable on a variety of computer devices, including mobile devices, and logged-in to by users of any of the different user access controls (e.g., user roles or user permissions). The point-of-sale system can be operable from any location supported by the device used to access the point-of-sale system, and need not necessarily be physically located in a retail store. The point-of-sale system can be configured to customize its user interface in accordance with the role and/or permissions of the logged-in user to provide the user with appropriate capabilities and views within the point-of-sale system. The point-of-sale system thus allows various parties to a lease-to-own transaction to manage different aspects of the lease-to-own transaction workflow via a unified system with a single point of entry, such as a single URL in a web browser or a single downloadable mobile-device application (“mobile app”).

The point-of-sale system can implement a dynamic micro-applications architecture that can facilitate the dynamic generation of different user interface views (e.g., a dashboard user interface view) of a point-of-sale computer system as displayed on a retailer or customer client device, customized based on the roles and/or permissions of an accessing user. The micro-application architecture can be configured to dynamically assemble different micro-applications that provide different management features, such as verification or price or inventory management, upon or after a time of user sign-in, with micro-applications selected based on role or permissions of the signing-in user. As an example, based on the architecture generated by the dynamic client-side assembly of micro-applications, a signing-in user accessing a dashboard URL or mobile app, which in either case is general to all users, can be presented with a customized dashboard interface tailored to the role or permissions of the signing-in user. A communication backbone can facilitate communications between different micro-applications. An event stream can maintain consistent data views between different user interface instances, such as different user dashboards.

The systems, devices, methods, and computer-readable media described herein can provide different micro-applications for different lease-to-own transaction management tasks. As one example, a micro-application can be provided for inventory management, allowing a retailer or administrator to add, edit, or delete data records corresponding to inventory items or classes of inventory items, for example. As another example, a micro-application can be provided for web lead management, allowing a retailer or administrator to store, categorize, and easily follow up on sales leads. As another example, a micro-application can be provided for account management, allowing a retailer or administrator to dynamically build list of customers for a retailer agent or employee to contact and easily follow up on past-due customers. As still other examples, different micro-applications can be provided for various store activities, e.g., allowing a customer to input and/or upload customer verification information and/or documents, or allowing a retailer or administrator to automatically, semi-automatically, or manually collect and verify information from a customer directly, without any requirement for paper.

The systems, devices, methods, and computer-readable media described herein can further provide a backend ensemble of cloud-based services that can provide automated pricing updating and revision functionality. This functionality can supplement the manual input and editing functionality that can be provided by one or more micro-services.

Among other advantages, the point-of-sale system can ensure a consistent, up-to-date presentation of inventory and transactions on its backend. Among other advantages, the point-of-sale system can provide for automated, semi-automated, or manual retailer verification of customer information, such as identity, residence, income, and personal reference information. Among other advantages, the pricing updating backend of the point-of-sale system can automatically update inventory pricing on an ongoing basis, reducing human labor involved in tracking changes to inventory pricing and ensuring that computer records reflect the pricing changes.

Still other benefits of the point-of-sale micro-applications architecture as described herein include the allowing of integration with third party systems and plug-ins. The point-of-sale micro-applications architecture as described herein allows flexibility to add new functionality with additions of new micro-applications, and micro-applications can be revised or removed on an individual basis with minimal or no impact to other micro-applications in the micro-applications architecture.

### System for Facilitating Retail Transaction Workflows

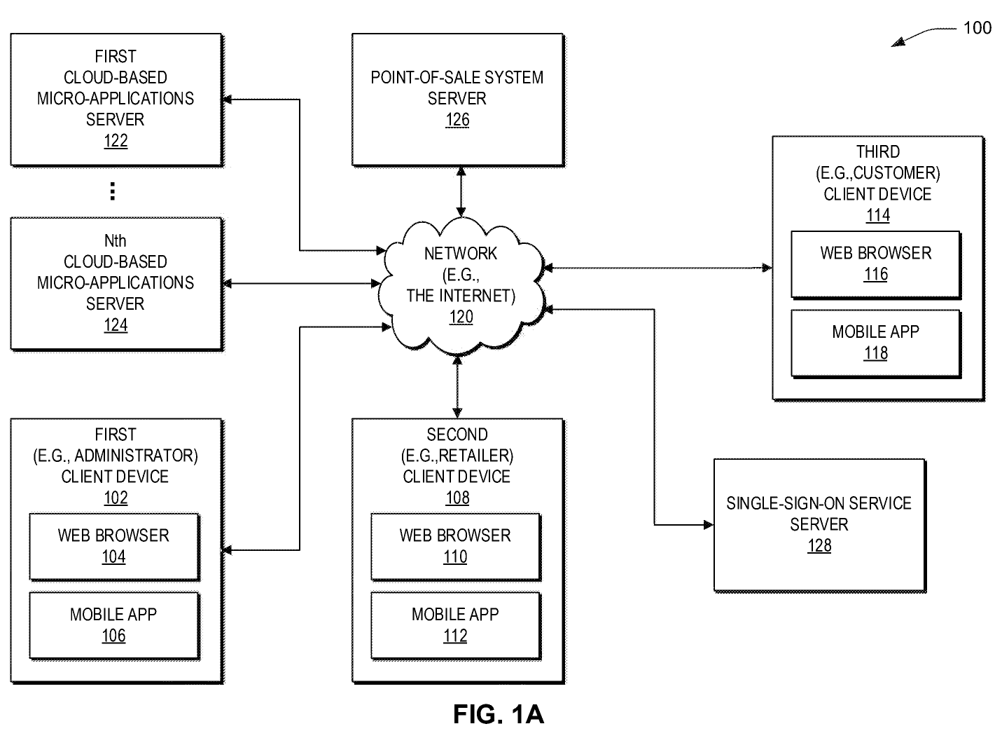

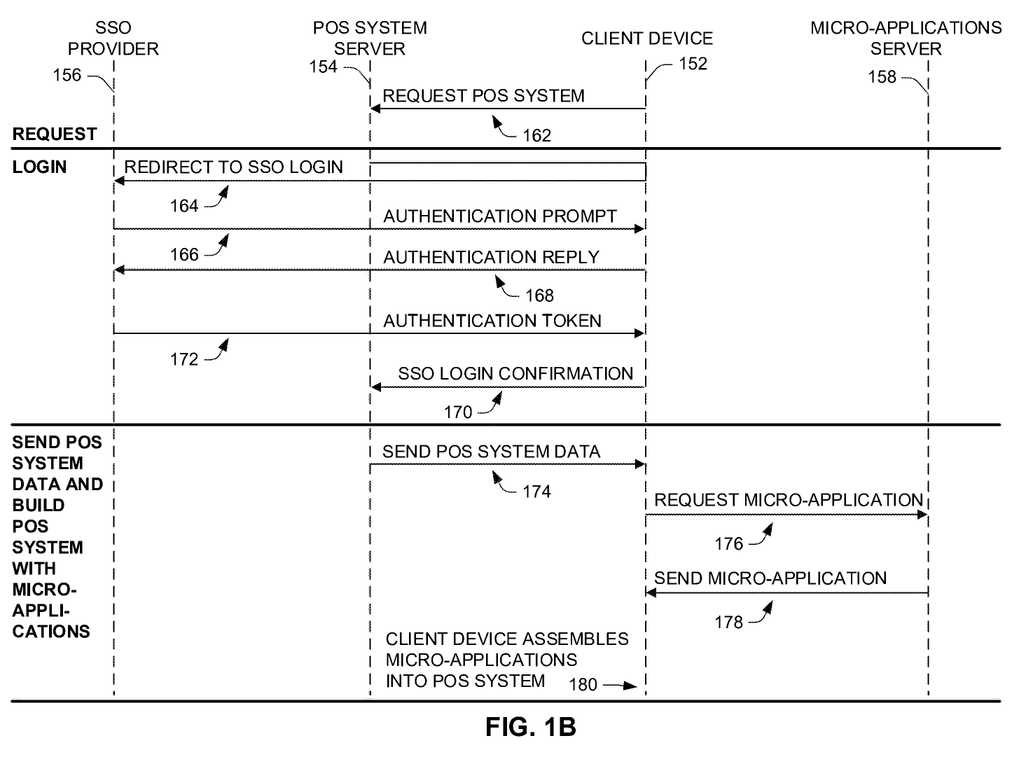

FIG. 1A is a block diagram of an example system 100 for facilitating retail transaction workflows, according to an embodiment. System 100 includes a first client device 102, a second client device 108, and a third client device 114 that can each be configured to access a point of sale system served at least in part by a point-of-sale system server 126 via a network 120 such as the internet. First client device 102 can, for example, be an administrator client device used by a backend administrator of the point-of-sale system. First client device 102 can include a web browser 104 and/or a mobile app 106 by which the first client device 102 may access the point-of-sale system. Second client device 108 can, for example, be a retailer client device used by an agent or employee of a retailer to access the point-of-sale system. Second client device 108 can include a web browser 110 and/or a mobile app 112 by which the second client device 108 may access the point-of-sale system. Third client device 114 can, for example, be a customer client device used by a customer of the retailer to access the point-of-sale system. Third client device 114 can include a web browser 116 and/or a mobile app 118 by which the second client device 114 may access the point-of-sale system. Each of the first client device 102, second client device 108, and third client device 114 may be a user device on which applications can be installed and utilized to monitor, administer, or engage in point-of-sale transactions, among other functions. Suitable such devices can include a smartphone, tablet computer, laptop computer, desktop computer, and wearable device such as a smart watch or smart glasses.

First client device 102, second client device 108, and third client device 114 can be communicatively coupled to point-of-sale system server 126 via network 120. Point-of-sale system server can be configured to serve data, such as markup code (e.g., Hypertext Markup Language (HTML) code) and scripting code (e.g., JavaScript), to each of the first client device 102, the second client device 108, and the third client device 114 upon an access request from any of the client devices. The access request can be, for example, in the form of a secure Hypertext Transfer Protocol (HTTPS) request, as may be made by any of the respective web browsers 104, 110, or 116 or any of the respective mobile apps 106, 112, or 118. The access request can be followed by a login procedure that follows a login protocol to securely log in an accessing device, from among first client device 102, second client device 108, and third client device 114. The login procedure can be handled by the point-of-sale system server 126 or, in some embodiments, by a third-party-provider single sign-on (SSO) service server 128. Despite having different roles and different permissions, each of the first client device 102, the second client device 108, and the third client device 114 can advantageously access the point-of-sale system by request to the point-of-sale system server 126 via a single URL that does not differ based on requesting device or its user access control (e.g., user role or user permissions). Point-of-sale system server 126 can be configured to recognize the respective role and/or permissions of any one of the first client device 102, the second client device 108, and the third client device 114 based on information exchanged during or after the login procedure.

After the login procedure and based on the recognized role and/or permissions of the respective requesting logged-in client device, the point-of-sale system server 126 can serve point-of-sale system data, such as markup code (e.g., HTML code) and scripting code (e.g., JavaScript) to the respective requesting logged-in client device. The point-of-sale system data sent by the point-of-sale system server 126 can include, for example, scripting code configured to further request micro-application code, such as further markup and scripting code, for any number of micro-applications from any of a number N of micro-applications servers, such as any one or more of first cloud-based micro-applications server 122 through Nth cloud-based micro-applications server 124. For example, the markup code and/or scripting code in the point-of-sale system data served to the respective requesting logged-in client device from the point-of-sale system server 126 can include one or more URLs that each point to one of the cloud-based micro-application servers 122 through 124.

Any one of the micro-applications servers can, in response to a request from the respective requesting logged-in client device, serve micro-application code to the respective requesting logged-in client device. The respective requesting logged-in client device can receive the micro-application code and can, in accordance with instructions in scripting code of the point-of-sale system data, integrate the received micro-application data as one or more micro-applications in a user interface of the point-of-sale system. The user interface can accordingly be customized to the role and/or permissions of the logged-in device. For example, the point-of-sale system server 126 can be configured to recognize the role and/or permissions of the logged-in device and further be configured to select one or more micro-applications to be provided to the logged-in client device as part of the user interface of the point-of-sale system as rendered on the respective web browser or mobile app of the logged-in client device, based on the recognized role or permissions.

As one example, the point-of-sale system server 126 can be configured to recognize the first client device 102 as having a backend administrator role, can select micro-applications pertinent to the backend administrator role, and can assemble point-of-sale system data that includes instructions for the first client device 102 to retrieve micro-application data from one or more of first cloud-based micro-applications server 122 through Nth cloud-based micro-applications server 124. The one or more micro-applications servers can, responsive to one or more requests from the first client device 102, serve corresponding backend-administrator-role micro-applications data, such as markup code (e.g., HTML code) and scripting code (e.g., JavaScript), to the web browser 104 or mobile app 106 of the first client device 102. In this way, the micro-applications data received by the first client device 102 is based on the recognized backend administrator role and/or associated permissions, as recognized by the point-of-sale system server 126 upon login of the first client device 102. The web browser 104 or mobile app 106 of the first client device 102 can then render the point-of-sale system user interface on the web browser 104 or mobile app 106 of the first client device 102 to include the backend-administrator-role micro-applications as selected by the point-of-sale system server 126.

As another example, the point-of-sale system server 126 can be configured to recognize the second client device 108 as having a retailer role, can select micro-applications pertinent to the retailer role, and can assemble point-of-sale system data that includes instructions for the second client device 108 to retrieve micro-application data from one or more of first cloud-based micro-applications server 122 through Nth cloud-based micro-applications server 124. The one or more micro-applications servers can, responsive to one or more requests from the second client device 108, serve corresponding retailer-role micro-applications data, such as markup code (e.g., HTML code) and scripting code (e.g., JavaScript), to the web browser 110 or mobile app 112 of the second client device 108. In this way, the micro-applications data received by the second client device 108 is based on the recognized retailer role and/or associated permissions, as recognized by the point-of-sale system server 126 upon login of the second client device 108. The web browser 110 or mobile app 112 of the second client device 108 can then render the point-of-sale system user interface on the web browser 110 or mobile app 112 of the second client device 108 to include the retailer-role micro-applications as selected by the point-of-sale system server 126.

As another example, the point-of-sale system server 126 can be configured to recognize the third client device 114 as having a customer role, can select micro-applications pertinent to the customer role, and can assemble point-of-sale system data that includes instructions for the third client device 114 to retrieve micro-application data from one or more of first cloud-based micro-applications server 122 through Nth cloud-based micro-applications server 124. The one or more micro-applications servers can, responsive one or more requests from the third client device 114, serve corresponding customer-role micro-applications data, such as markup code (e.g., HTML code) and scripting code (e.g., JavaScript), to the web browser 116 or mobile app 118 of the third client device 114. In this way, the micro-applications data received by the third client device 114 is based on the recognized customer role and/or associated permissions, as recognized by the point-of-sale system server 126 upon login of the third client device 114. The web browser 116 or mobile app 118 of the third client device 114 can then render the point-of-sale system user interface on the web browser 116 or mobile app 118 of the third client device 114 to include the customer-role micro-applications as selected by the point-of-sale system server 126.

Each of the first client device 102, second client device 108, and third client device 114 can access and use the point-of-sale system at different times or concurrently. A number of other client devices (not shown) of various roles and permissions can likewise access and use the point-of-sale system at different times or concurrently. System 100 can accommodate a number of different roles and permissions within the role categories represented in FIG. 1A. For example, in different embodiments, there may be a variety of different administrator permissions levels each having access to different combinations of micro-applications in the point-of-sale system, a variety of different types of retailer user accounts each having access to different combinations of micro-applications in the point-of-sale system, and/or different types of customer accounts each having access to different combinations of micro-applications in the point-of-sale system.

In some embodiments, the point-of-sale system server 126 and one or more of the micro-applications servers 122 through 124 are only a single physical machine. In other embodiments, different ones of the point-of-sale system server 126 and the micro-applications servers 122 through 124 are different physical machines. In some examples, the micro-applications servers 122 through 124 are cloud-based and can be implemented using a so-called “serverless” cloud services architecture.

The sequence diagram of FIG. 1B illustrates the sequence of operations in a process by which a client device 152 can receive micro-application data so as to assemble different micro-applications into a user interface presented by a web browser or mobile app of client device 152. In the sequence diagram of FIG. 1B, client device 152 can correspond, for example, to any one of first client device 102, second client device 108, or third client device 114 in FIG. 1A. Point-of-sale (POS) system server 154 in FIG. 1B can correspond to point-of-sale system server 126 in FIG. 1A. SSO provider 156 in FIG. 1B can correspond to single-sign-on service server 128 in FIG. 1A. Micro-applications server 158 in FIG. 1B can correspond to any of first cloud-based micro-applications server 122 through Nth cloud-based micro-applications server 124.

At 162, client device 152 transmits a message to POS system server 154 (e.g., via the internet) containing a request to receive a POS system. The request can be, for example, an HTTPS request and can be made, for example, by accessing a dashboard URL, which can appear in an address bar of a web browser running on client device 152. POS system server 154 receives the message from client device 152 and can determine whether or not client device 152 is logged in. For example, POS system server 154 can check for the presence of a cryptographic authentication token in the request.

Based on determining that client device 152 is not yet logged in, at 164, POS system server 154 can redirect client device 152 to SSO provider 156 for authentication. At 166, SSO provider 156 can send an authentication prompt to client device 152. At 168, the user can log in with user credentials. The credentials can include, as examples, a user name and password or passkey, and additional authentication factors (not shown in FIG. 1B) may be required to complete the login. SSO provider verifies the credentials and, if successful, provides a login issues a cryptographic authentication token to client device 152 at 172 and redirects client device 152 back to POS system server 154 with the cryptographic authentication token. At 174, upon validating the cryptographic authentication token, POS system server 154 and prepares POS system data to send to client device 152. Issuance and authentication of cryptographic authentication tokens can make use of Secure Authentication Markup Language (SAML) and OpenID Connect/OAuth 2.0 standards, as examples.

Alternatively, if, after the initial request for request for the POS system at 162, POS system server 154 determines that the cryptographic authentication token is present and valid, login actions 164 through 170 can be skipped and POS system server 154 can proceed to prepare and send POS system data at 174.

The preparation of the POS system data can include POS system server 154 determining role(s) and/or permissions associated with the user account used by client device 152 to log in, determining one or more micro-applications permitted for the determined role(s) and/or permissions. For example, POS system server 154 may store user data in a data store, e.g., in the form of a user database or data table. The user data may indicate, for each user one or more roles of the user and/or other permissions information. POS system server 154 may further store micro-applications access data in the data store or another data store, e.g., in the form of a micro-applications access database or data table. The micro-applications access database or data table can relate roles and/or permissions to micro-applications accessible to users having the indicated roles and/or permissions.

The preparation of the POS system data can further include POS system server 154 determining scripting code configured to access the determined one or more micro-applications permitted for the logged-in user. As an example, the determined scripting code can include instructions that, when executed, retrieve one or more micro-applications, e.g., from micro-applications server 158. For example, the determined scripting code can include a micro-application URL from which to retrieve a micro-application. Having determined the scripting code capable of accessing the determined one or more micro-applications, POS system server 154 can include the determined scripting code in the POS system data 174. Thus, POS system data 174 does not serve the micro-applications themselves at 174, but rather, transmits scripting code that includes URLs or other pointers by which client device 152 can access and retrieve the micro-applications.

Client device 152 receives POS system data 170, which, as described above, can include markup code and scripting code. A web browser or mobile app running on client device 152 renders the markup code and executes the scripting code. In some embodiments, where the scripting code includes a micro-application URL from which to retrieve a micro-application, the URL from which to retrieve the micro-application is not displayed in an address bar of the web browser. Instead, the web browser continues to display the dashboard URL in the address bar.

At 176, the execution of the scripting code can prompt client device 152 to request a micro-application from micro-applications server 158. For example, the web browser or mobile app of client device 152 can make an HTTPS request to a micro-application URL provided by POS system server 154 in PO system data sent at 174, the URL pointing to micro-applications server 158. The request sent at 176 can include a cryptographic authentication token, which can be either the cryptographic authentication token provided at 172 by SSO provider 156, or a different cryptographic authentication token. In receipt of the request, micro-applications server 158 verifies the cryptographic authentication token sent with the micro-application request at 176 and, at 178, sends the request micro-application to client device 152. The transmissions at 176 and 178 can be repeated any number of times to request any number of different micro-applications from any number of different micro-applications servers (e.g., first cloud-based micro-applications server 122 through Nth cloud-based micro-applications server 124 in FIG. 1A). The micro-application can comprise one or both of markup code or scripting code. Micro-applications server 158 can be cloud-based and can provide its functionality through a “serverless” cloud services architecture.

At 180, having received a micro-application from micro-applications server 158, or having received multiple micro-applications as described above, client device 152 can assemble the one or more received micro-applications into a user interface that can be rendered for display by the web browser or mobile app of the client device 152. The displayed user interface can include the one or more received micro-applications. For example, each of the one or more received micro-applications can be rendered in a separate HTML inline frame (iframe) of the displayed user interface.

In various embodiments, because micro-applications used in the client device user interface are retrieved from micro-applications server rather than from a single point-of-sale system server, load on the POS system server 154 is reduced.

### Example Point-of-Sale System User Interface Views

Different scripting code sent to different client devices can cause the different client devices to retrieve micro-applications and assemble the micro-applications into dynamic point-of-sale system user interfaces for enabling management of product leasing information. Example product leasing information management features include customer verification and inventory price management. In embodiments, each of the micro-applications can include markup code (e.g., HTML) and scripting code (e.g., JavaScript).

In embodiments, the scripting code of one or more micro-applications can be configured to generate dynamic elements that can continuously or periodically update themselves based on point-of-sale system data the scripting code retrieves or receives from data sources, such as one or more databases or data caches, that are external to the client device on which the point-of-sale system is rendered and displayed. Accordingly, in some embodiments, the micro-applications can provide current (e.g., up-to-the-minute) views of point-of-sale system data that is consistent across different instances of the point-of-sale system (e.g., on different client devices) without necessitating user interactions to refresh the views. In some embodiments, the micro-applications can provide user interface controls to manually refresh data views. The point-of-sale system data retrieved or received from the data sources by the micro-application scripting code can be provided by an event stream. In embodiments, one or more of the micro-applications can include interactive user controls to perform product leasing information management functions or point-of-sale system administration functions. Example user interfaces are described below.

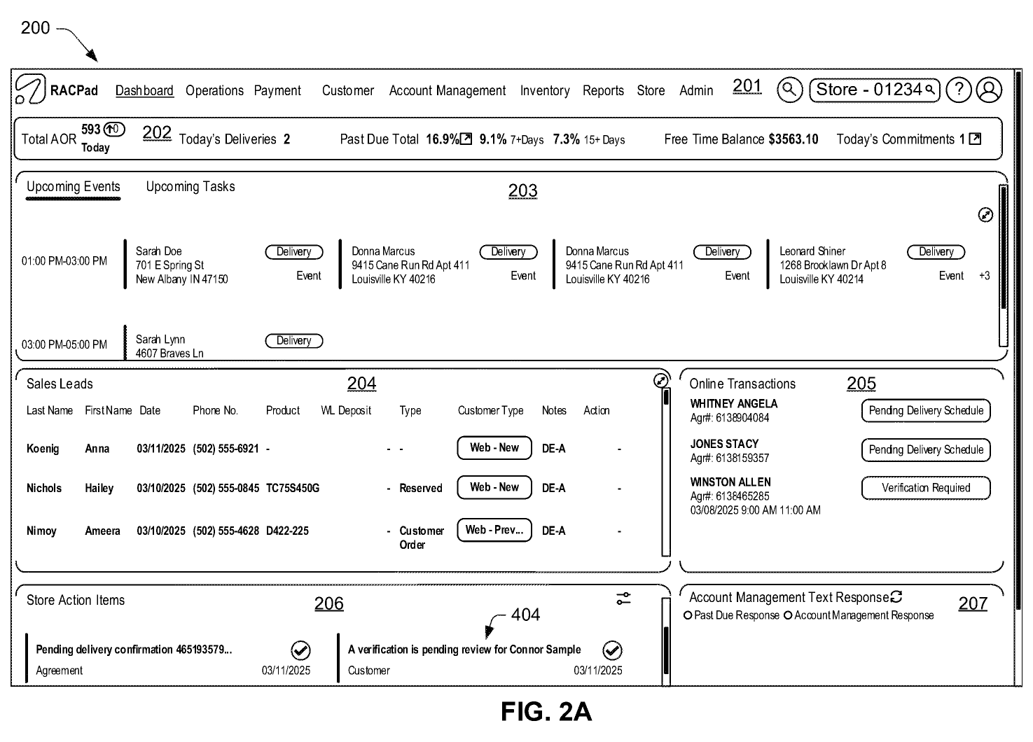

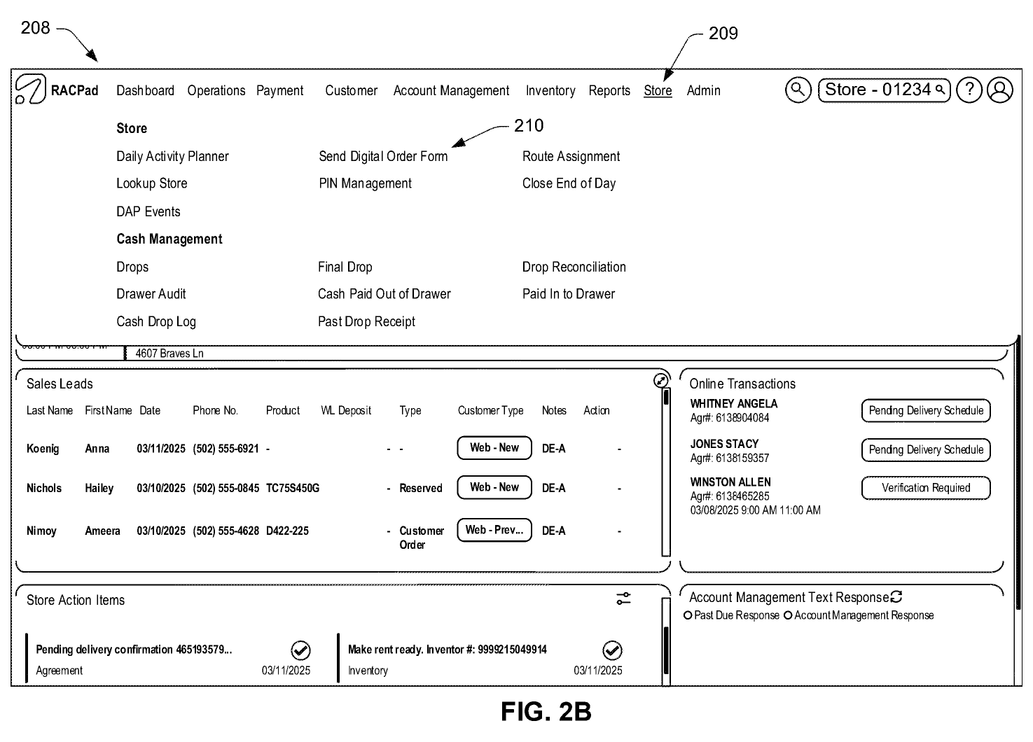

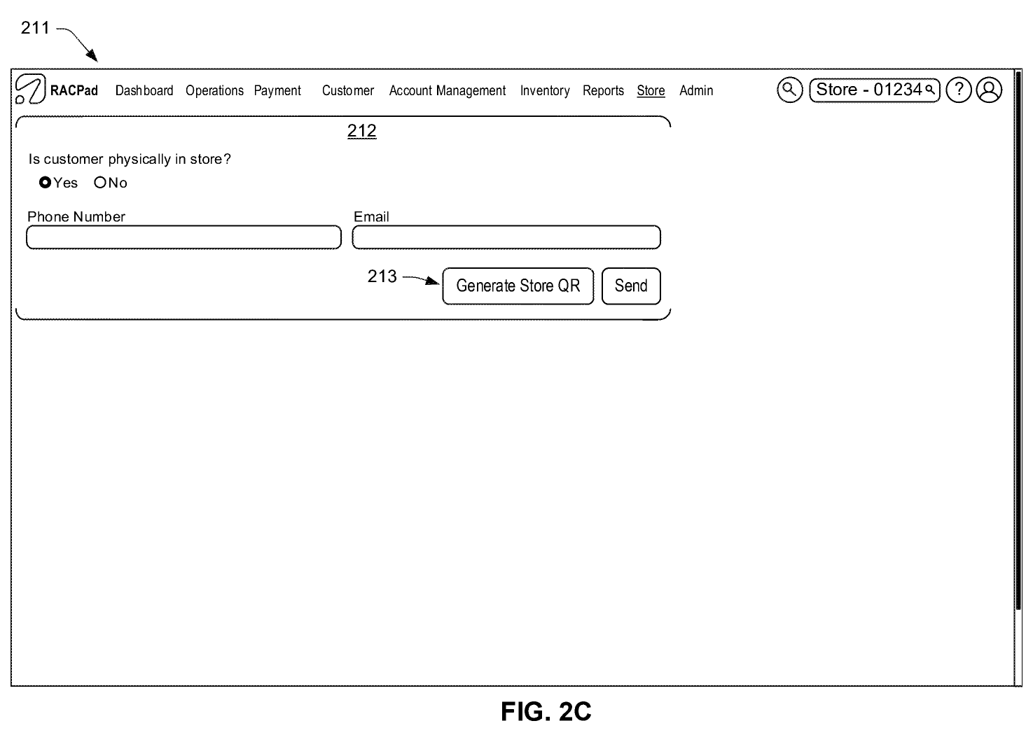

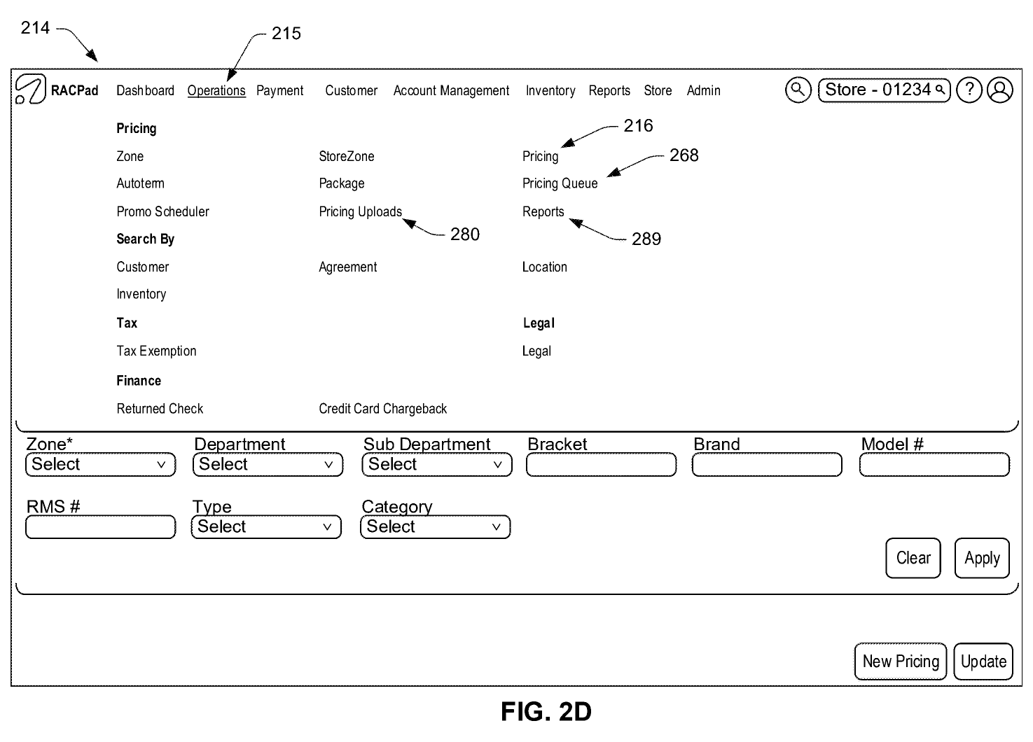

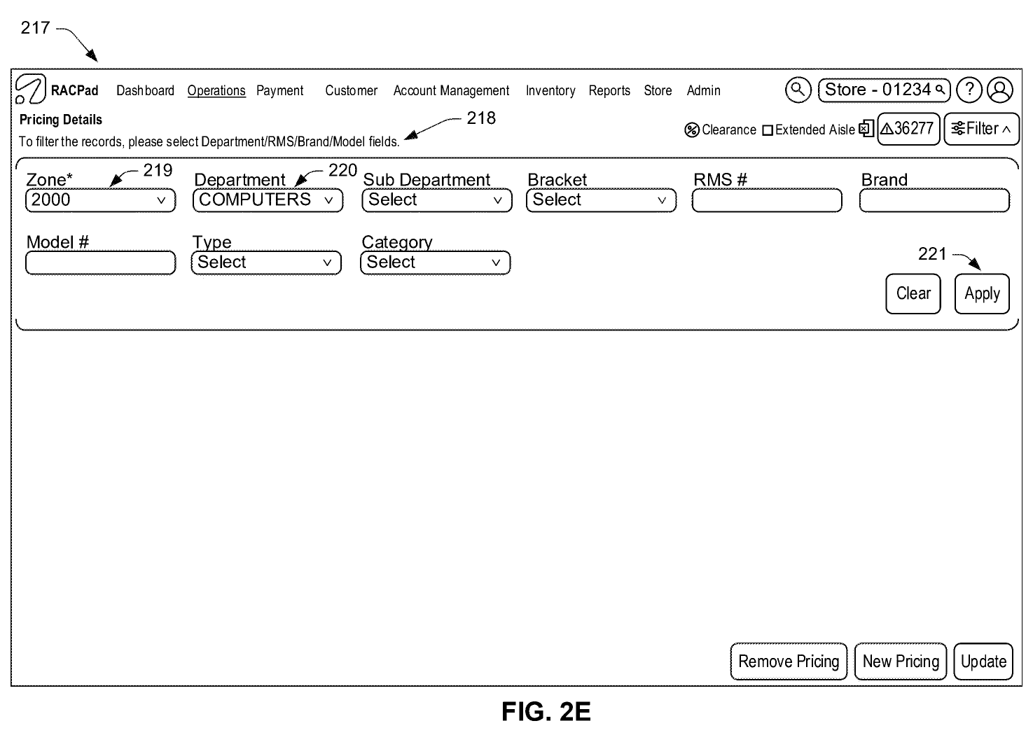

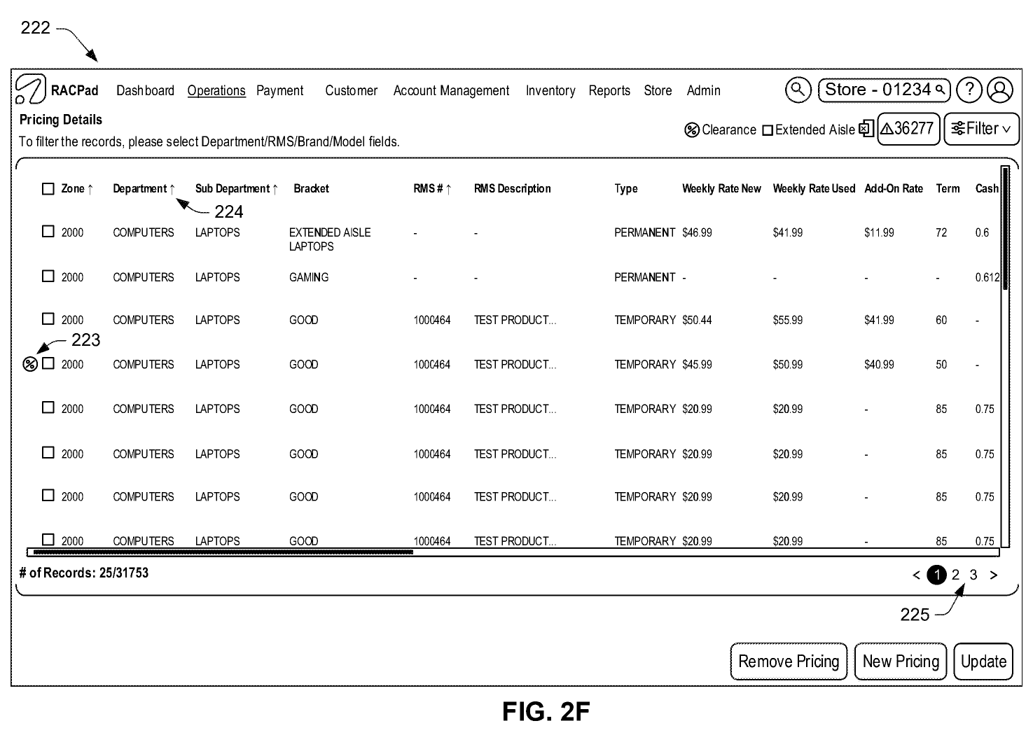

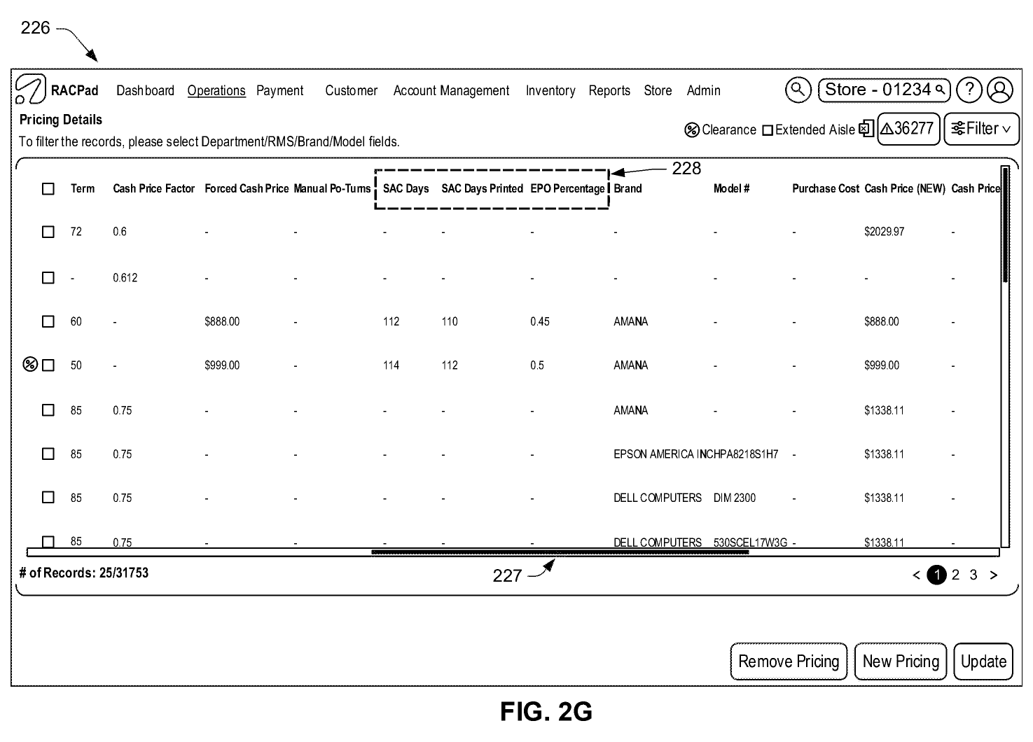

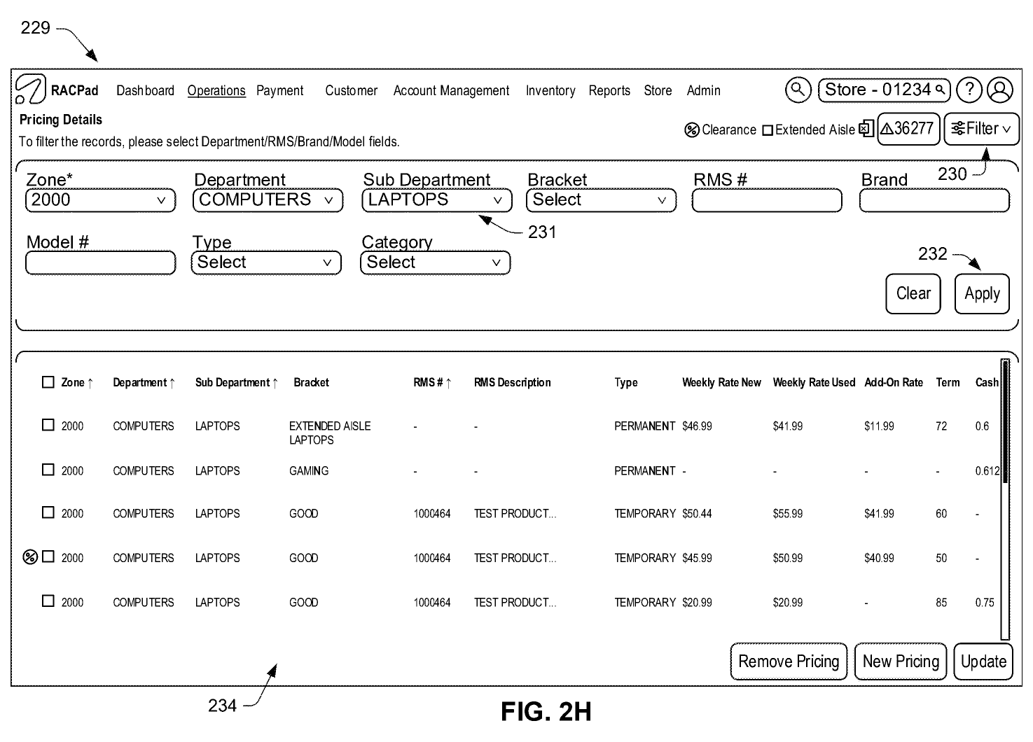

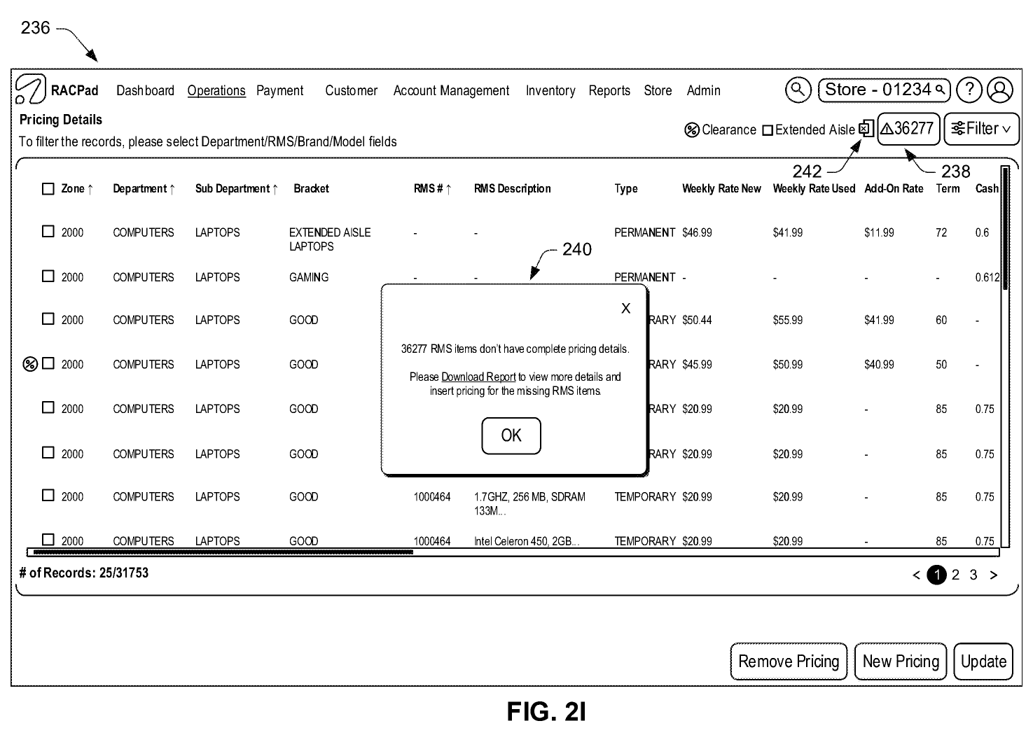

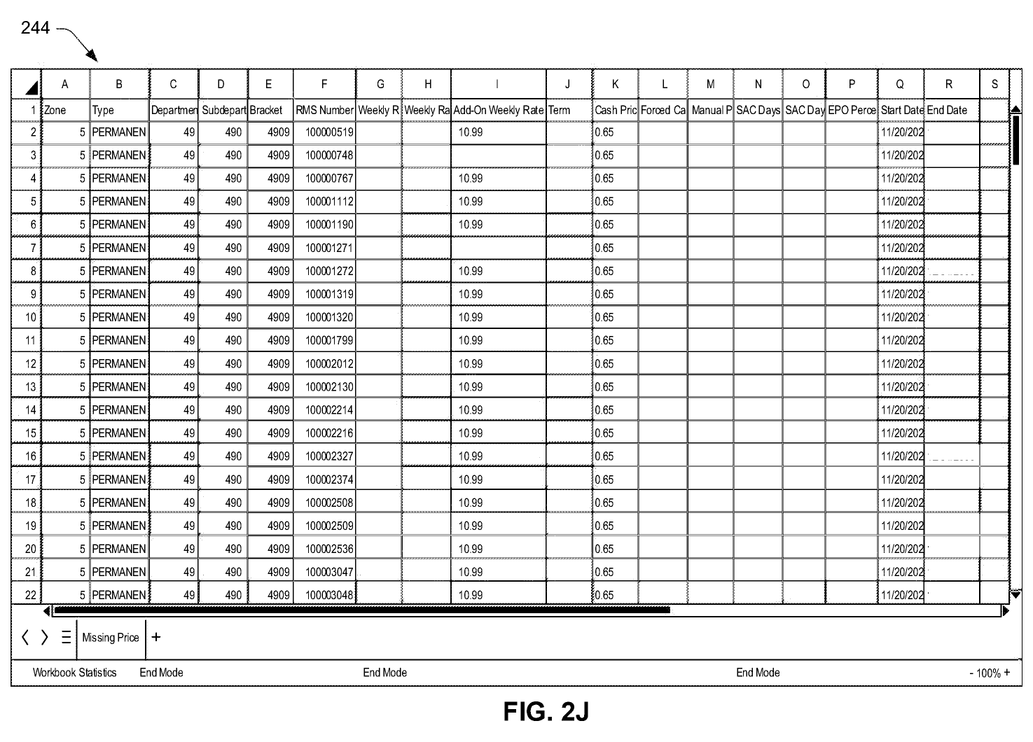

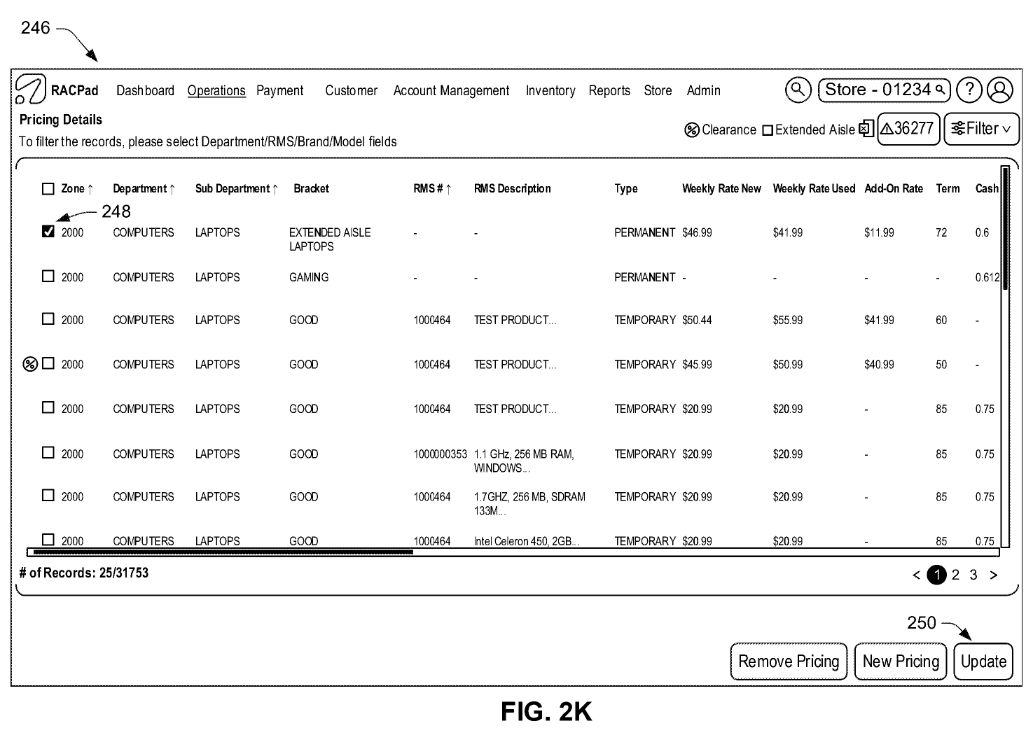

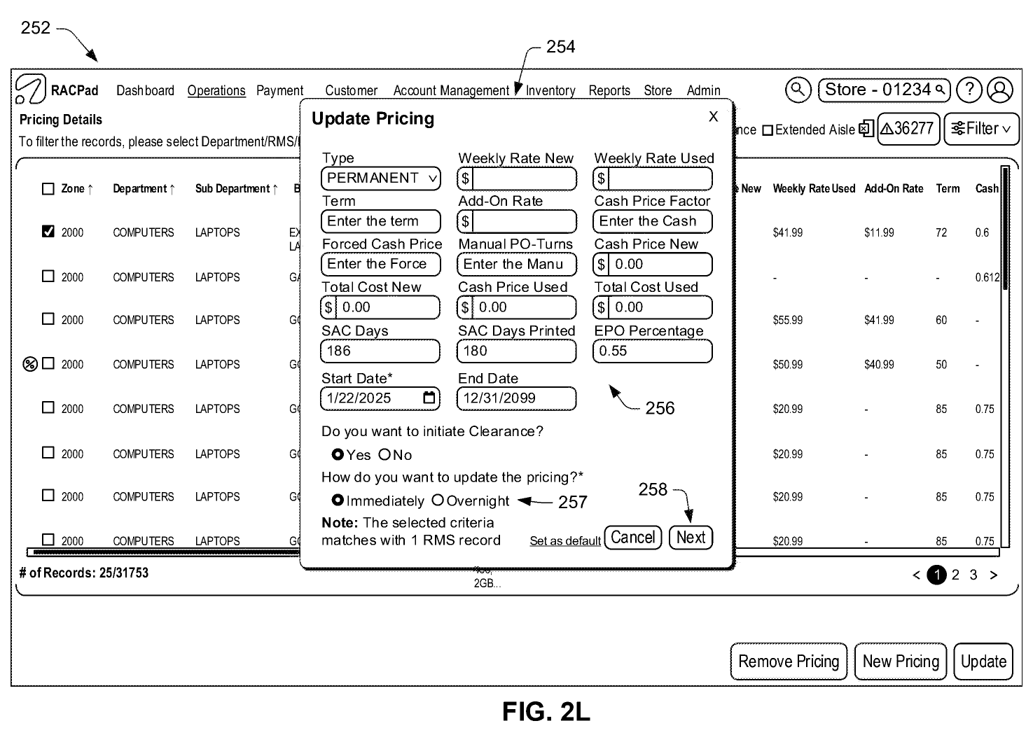

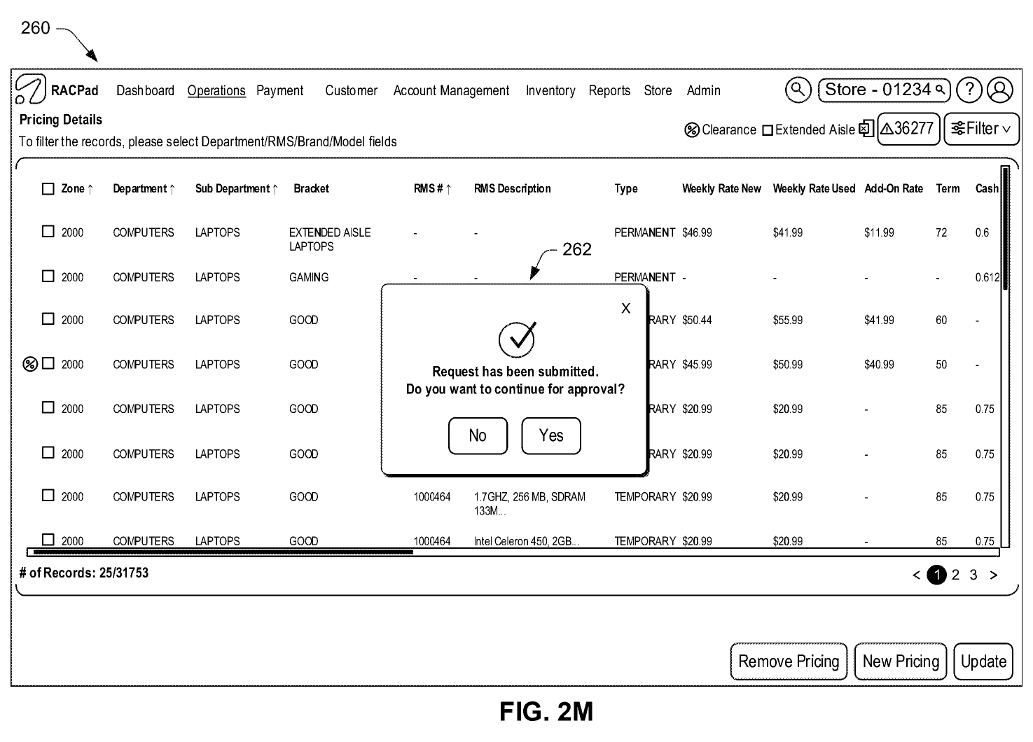

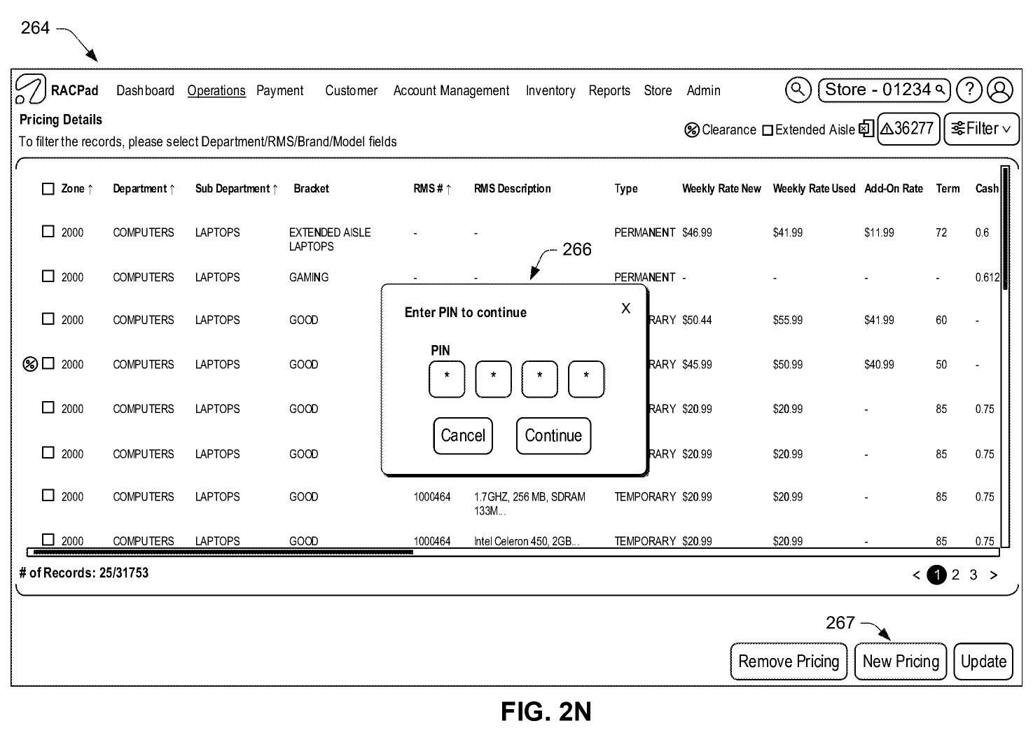

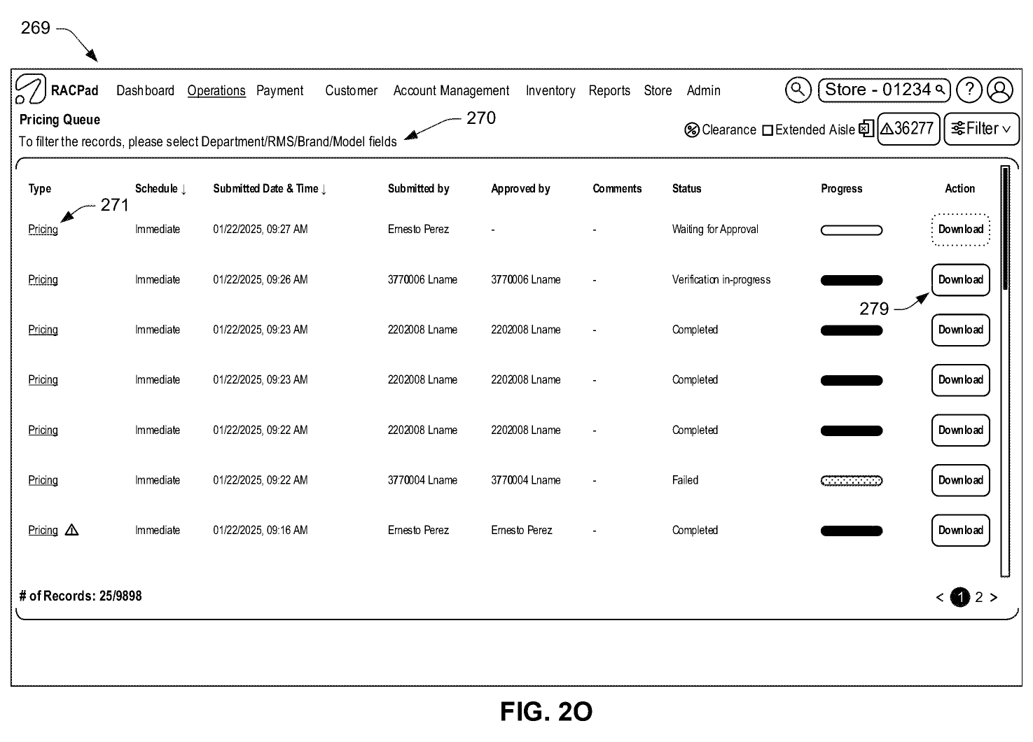

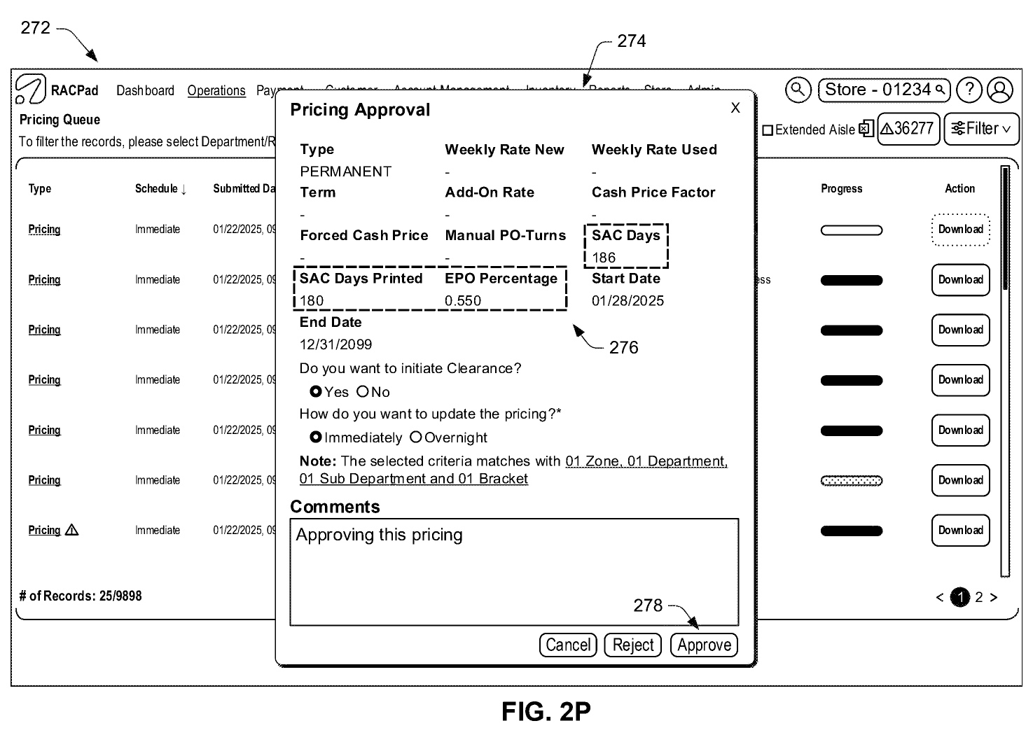

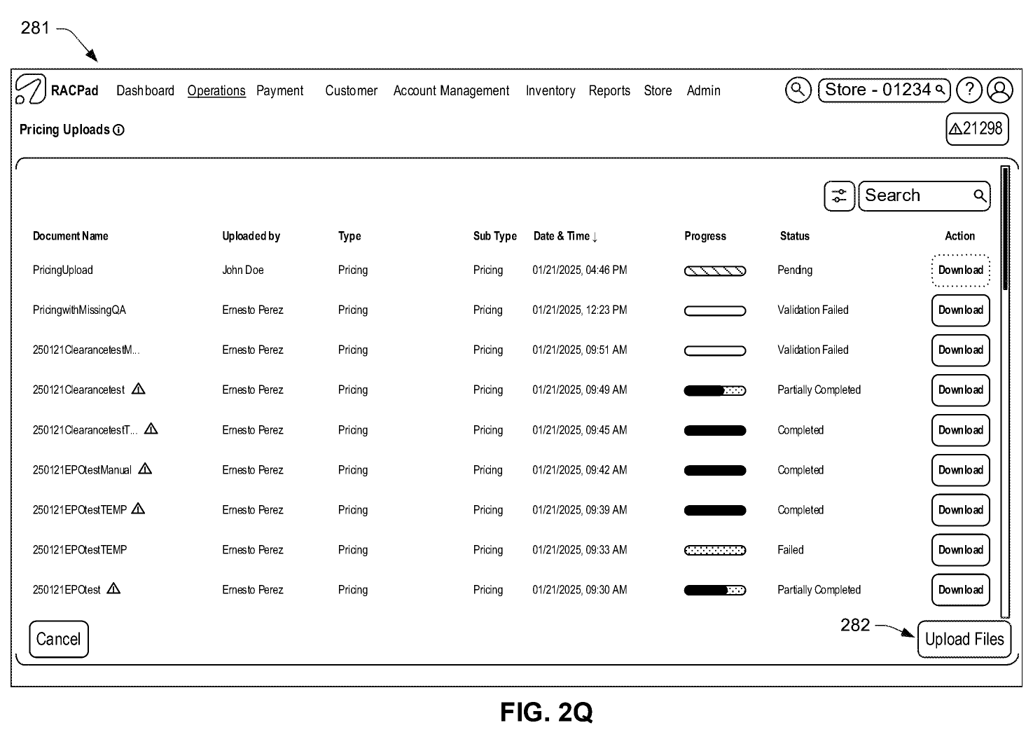

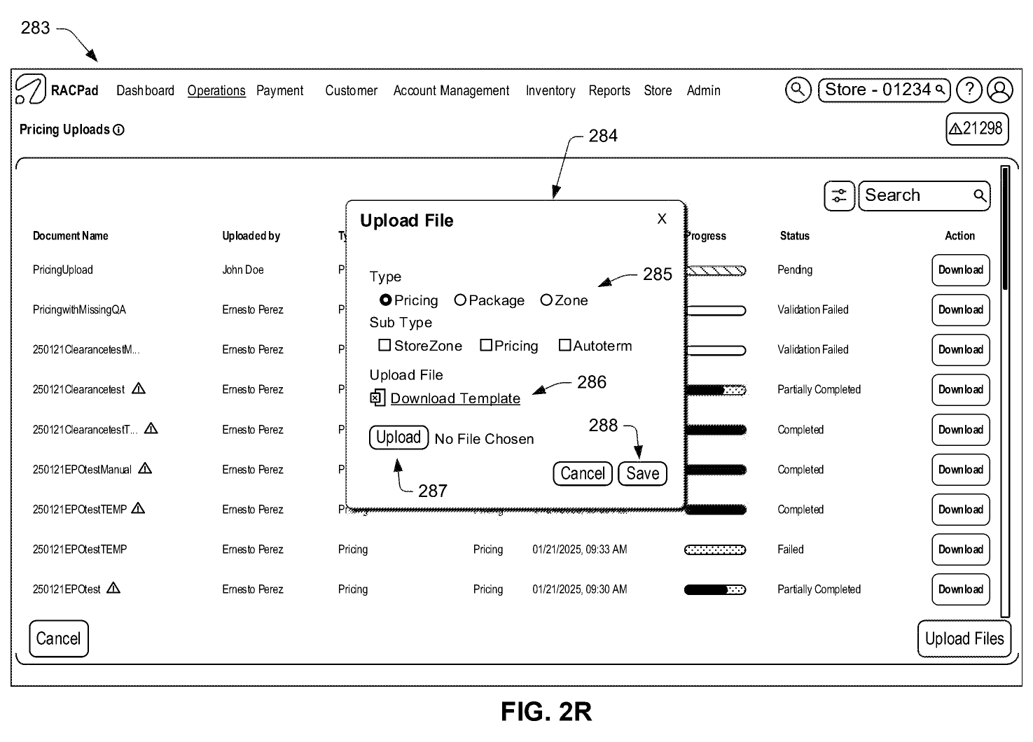

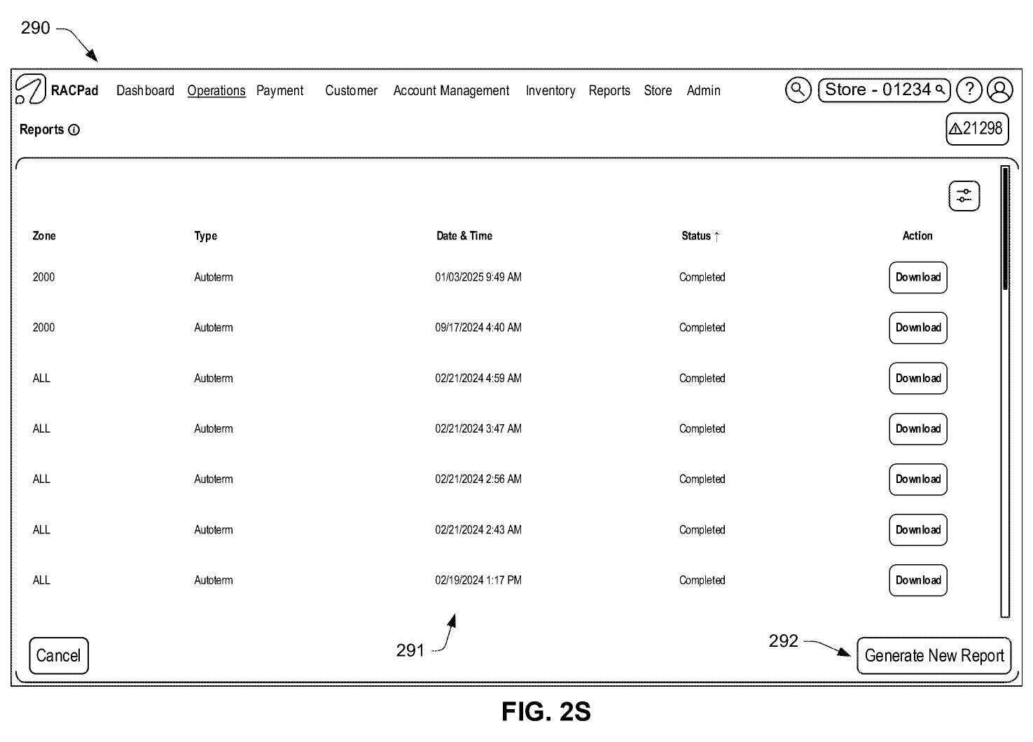

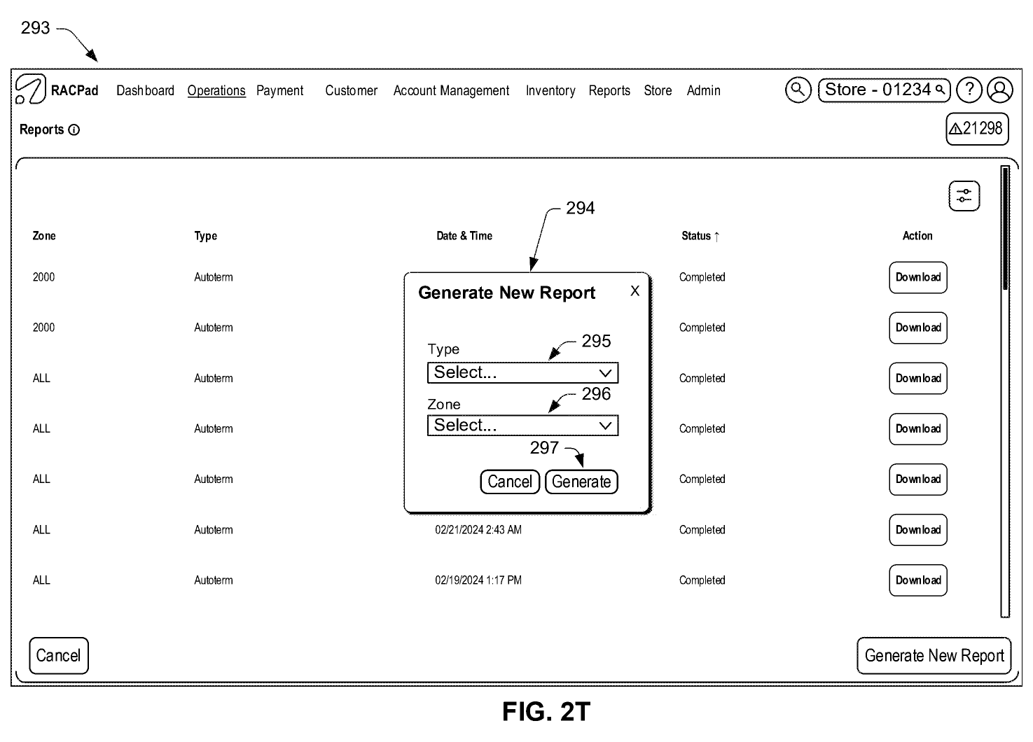

FIGS. 2A-2I and 2K-2T illustrate example user interface views of a point-of-sale system for facilitating retail transaction workflows, as presented to a retailer user or backend administrator user, according to some embodiments. Each of the example user interface views can be rendered in a web browser, such as web browser 104 or web browser 110 of FIG. 1A, or by a mobile app, such as mobile app 106 or mobile app 112 of FIG. 1A. The example user interface views can be generated using systems as described above with regard to the example of FIG. 1A and processes as described above with regard to the example of FIG. 1B. For example, the example user interface views can be generated by a web browser or mobile app of a client device assembling micro-applications client-side, with the individual micro-applications being retrieved, e.g., via URLs that can be accessed by scripting in a way that is invisible to the end user, from one or more micro-applications servers different from a main point-of-sale system server. Each of the one or more micro-applications servers can be configured as cloud-based systems that provide a serverless architecture.

Dashboard interface view 200 of FIG. 2A illustrates an example dashboard interface of the point-of-sale system, e.g., to an administrator client device, such as first client device 102 of FIG. 1A, and/or to a retailer client device, such as second client device 108 of FIG. 1A. Dashboard interface view 200 can serve as a point of entry to the point-of-sale system and can be accessed, for example, by accessing a dashboard URL within a web browser or by starting a dedicated mobile app on a client device, as described above. User log-in can be required to view dashboard interface view 200. Thereafter, from within the point-of-sale system, dashboard interface view 200 can be accessed by a Dashboard link or drop-down menu option in menu 201 of the dashboard interface, as shown underlined at the left of menu 201 in FIG. 2A.

As shown (but not labeled with separate reference numerals) in FIG. 2A, menu 201 can further include menu options for various other aspects of the point-of-sale system (e.g., Operations, Payment, Customer, Account Management, Inventory, Reports, Store, and Admin), a control for a global search of the point-of-sale system, a display or control indicating or allowing change of a store (e.g., by name, number, or other identifier), a control to access help documentation or other point-of-sale system usage assistance functionality (e.g., instructional videos or a large-language-model-based chatbot), and/or a user account control by which user account log-out, user account settings, and/or user account change functionality can be accessed. In embodiments, the menu options can be hyperlinks and/or tabs for different respective drop-down menus.

For ease-of-use purposes, menu 201 can, in different embodiments, remain substantially the same in appearance and function across different interface views of the point-of-sale system, and/or can be customized according to the user access control (e.g., user role or user permissions) of the logged-in user. As one example, users that lack administrative roles or permissions levels would not be displayed an Admin menu option in menu 201. As shown and described in greater detail below with regard to FIGS. 2B and 2D, menu 201 can have user-interactive features, such as displaying more detailed drop-down menus when its various menu options are hovered-over or clicked on.

Menu 201 can constitute its own micro-application that can create, control, and integrate the other micro-applications that make up the Dashboard interface view 200. In this way, menu 201 can be a parent micro-application, with other micro-applications displayed in Dashboard interface view 200 being child micro-applications to the menu 201. For example, scripting code that generates menu 201 can include instructions that establish or define iframes within an HTML document, e.g., one iframe for each other micro-application within Dashboard interface view 200, and instructions with URLs to each other micro-application to be downloaded and rendered within the iframes. As another example, a child micro-application rendered within Dashboard interface view 200 can be configured to send data or instructions to the parent micro-application menu 201, which can be configured to relay all or a portion of the data or instructions to a different one of the child micro-applications. The parent micro-application menu 201 can thus serve as a communication backbone between and among its child micro-applications.

Dashboard interface view 200 can further include a statistical summary micro-application 202 that can provide useful numerical information organized for easy at-a-glance user consumption. As examples, statistical summary micro-application 202 can indicate a current-day accounts on rent (AOR) number, a number indicating a change in AOR over the previous day, a number of deliveries to be performed in the current day, percentages of past-due totals (e.g., over all time, and, separately, within the past 7-plus days and within the past 15-plus days), a free time balance in units of currency (e.g., United States dollars), and a number of commitments for the present day.

Dashboard interface view 200 can further include an upcoming events/tasks micro-application 203 that provides a display of upcoming events and/or upcoming tasks. For example, as shown in FIG. 2, upcoming events can include displays of individual deliveries and the names and addresses of the delivery recipients, organized by delivery time slot. The upcoming events/tasks micro-application 203 can, as in the illustrated example, be switchable between separate upcoming events and upcoming tasks views, selectable by a link or control at the top of the upcoming events/tasks micro-application 203.

Dashboard interface view 200 can further include a sales leads micro-application 204 that can provide a scrollable table display of sales lead information. The sales lead information can include, for example, names, dates, and phone numbers (and/or other contact information) of sales lead individuals, associated product numbers, associated deposit amounts, lead types, customer types, notes codes, and action information.

Dashboard interface view 200 can further include an online transactions micro-application 205 that can provide a scrollable display of online transactions and their associated statuses, such as “pending delivery schedule” or “verification required.” The online transactions as displayed can include names of associated individual customers and transaction identifiers (e.g., numbers). In some instances, the online transactions as displayed can further include date and time information.

Dashboard interface view 200 can further include a store action items micro-application 206 that can provide a scrollable display of action items and their associated statuses (e.g., incomplete, or completed, as may be indicated by a checkmark). Dashboard interface view 200 can further include an account management text response micro-application 207 that can provide, e.g., a color-coded display of past-due responses, account management responses, and/or other responses.

Store menu interface view 208 of FIG. 2B illustrates an example Store menu interface of the point-of-sale system, e.g., to an administrator client device, such as first client device 102 of FIG. 1A, and/or to a retailer client device, such as second client device 108 of FIG. 1A. Store menu interface view 208 can be accessed, for example, by hovering or clicking on the Store menu item 209, which expands a Store menu. The example Store menu illustrated in FIG. 2B includes a menu option for Send Digital Order Form 210.

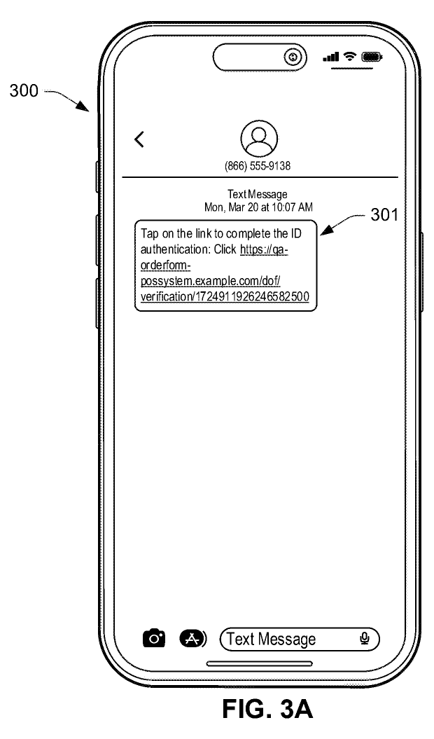

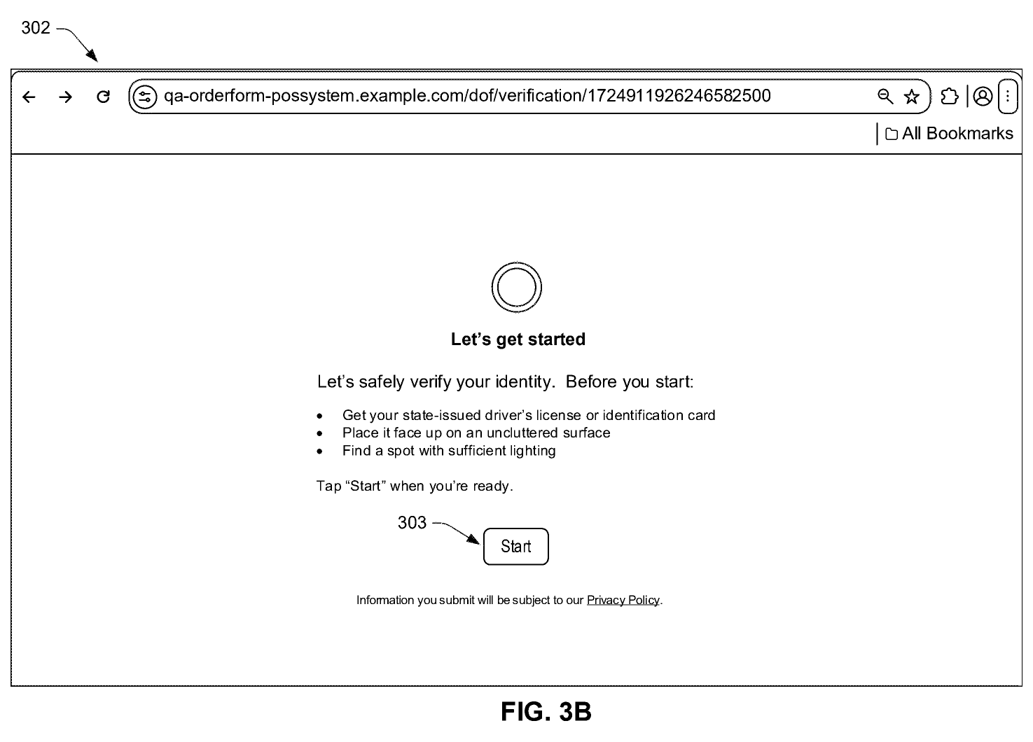

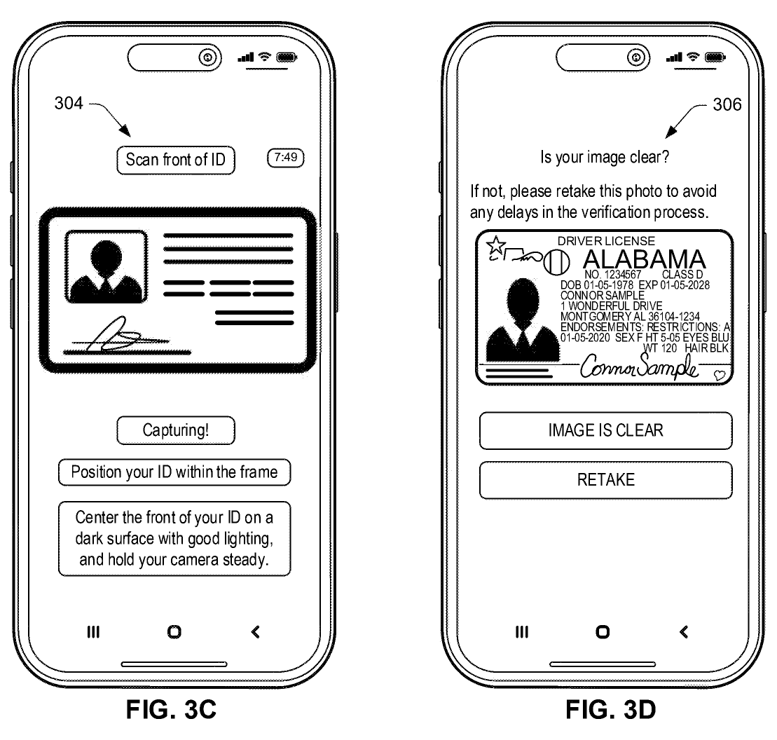

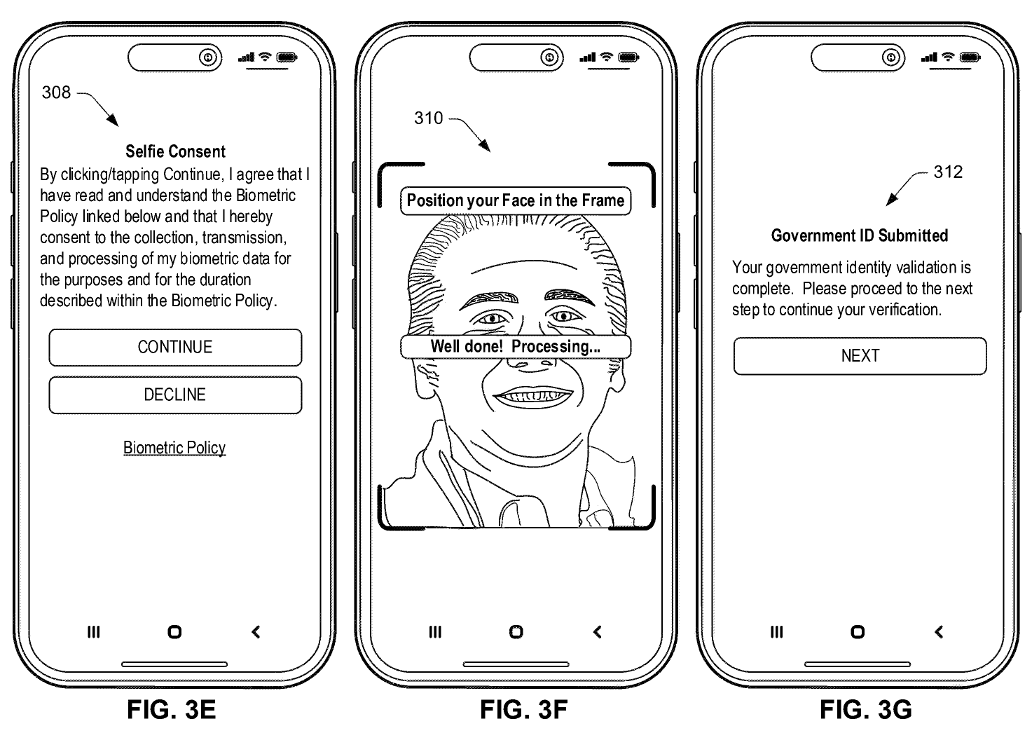

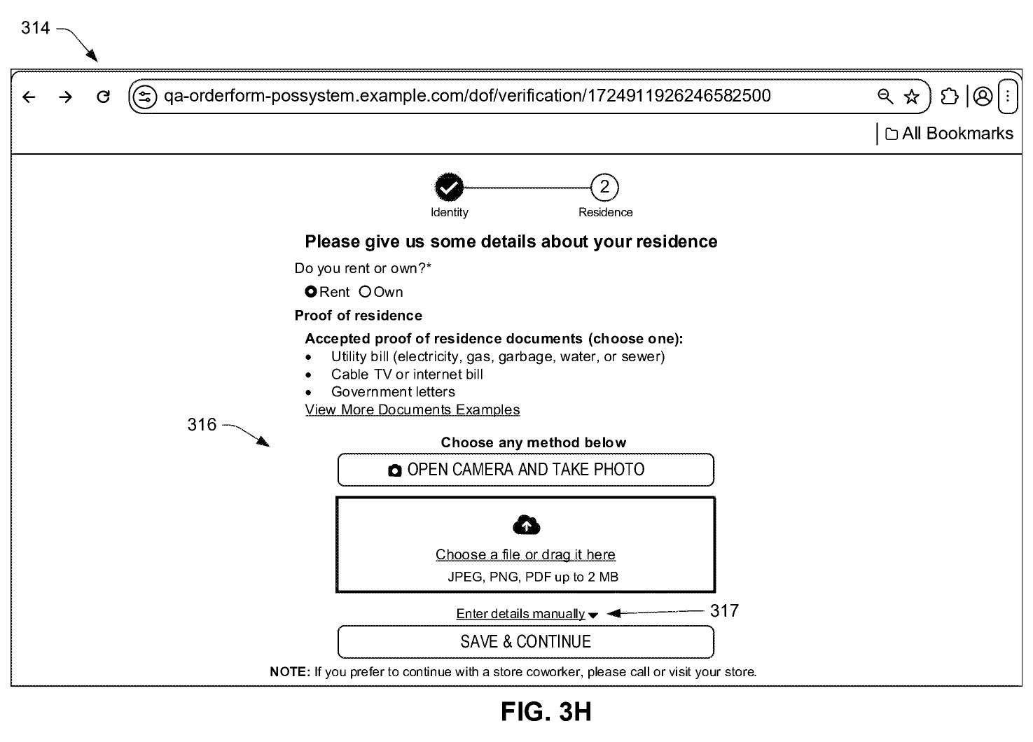

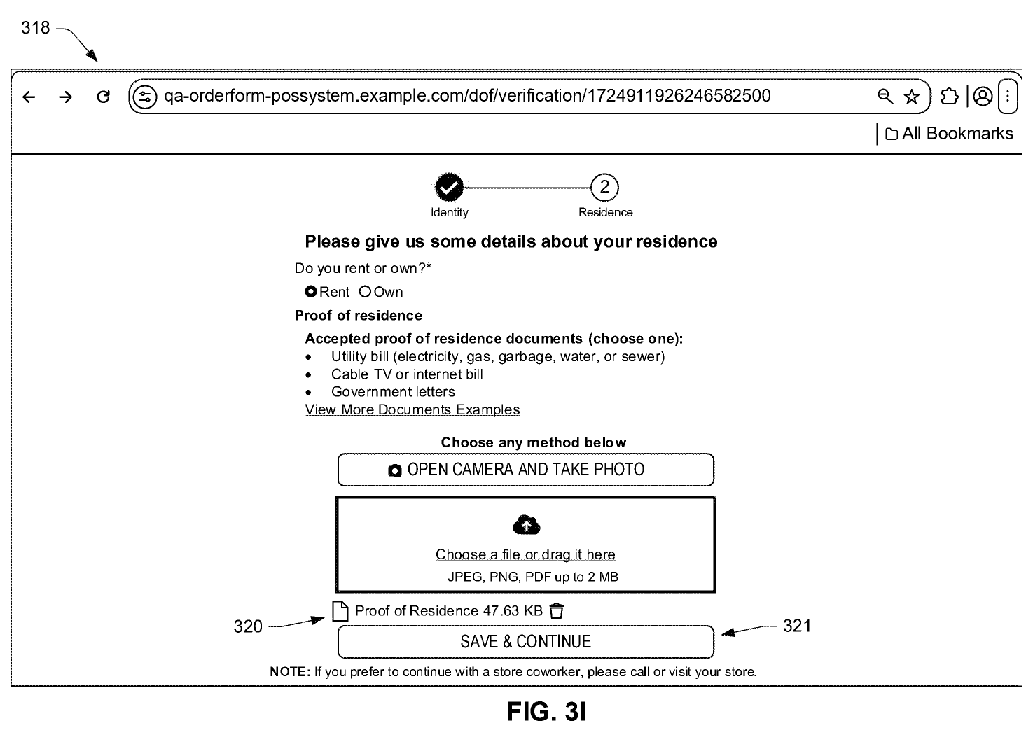

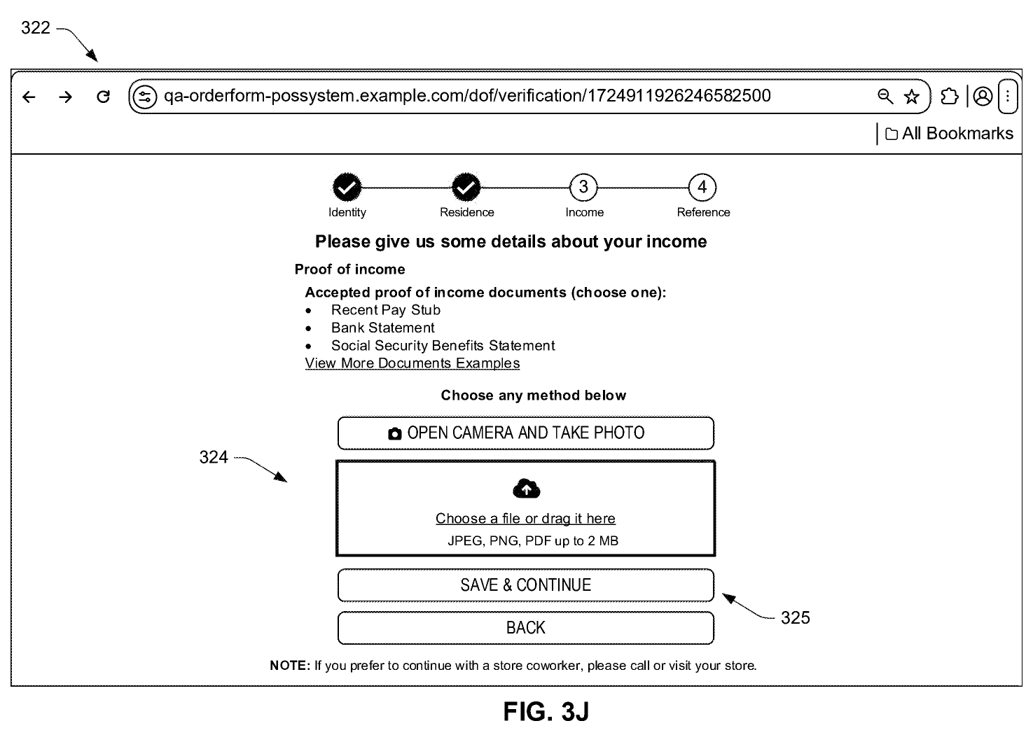

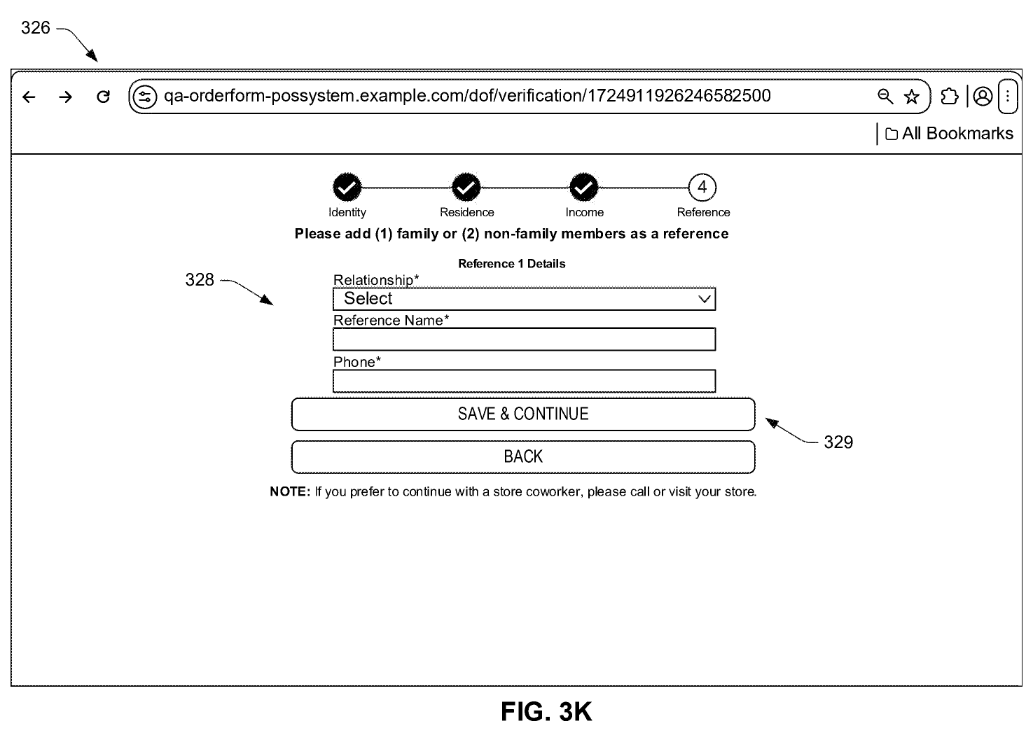

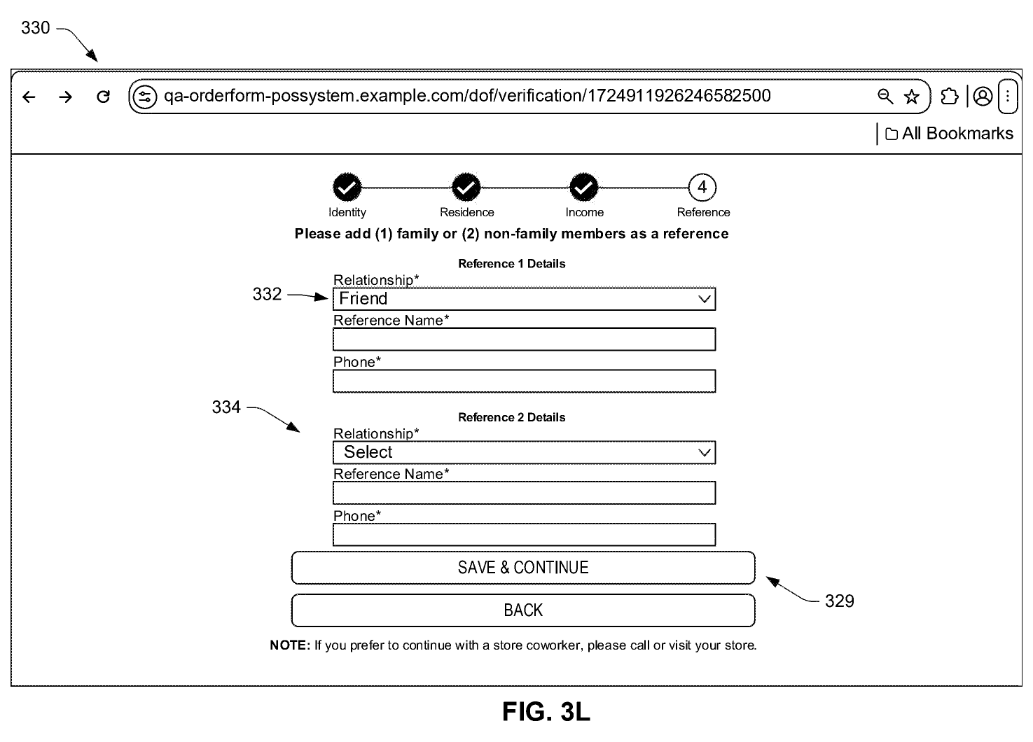

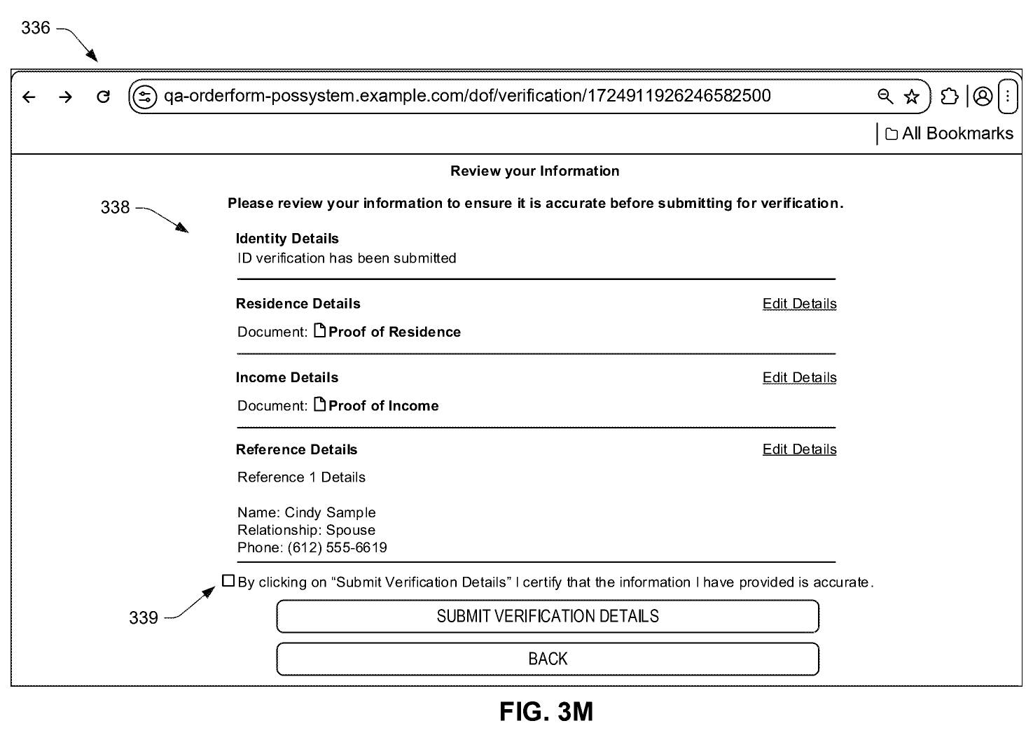

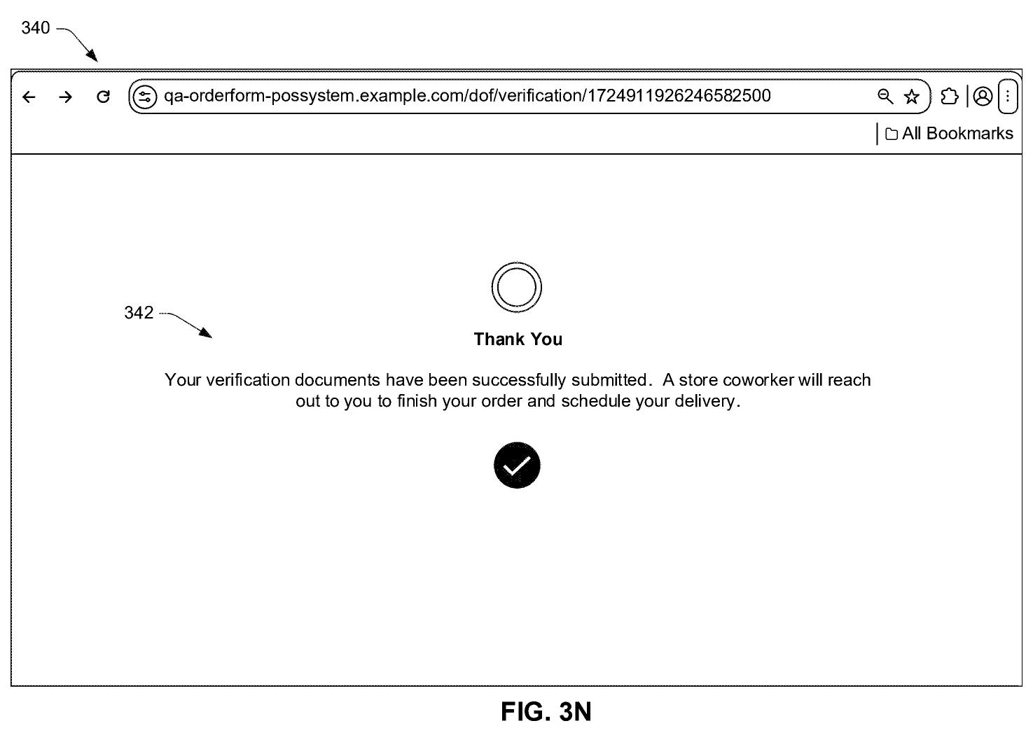

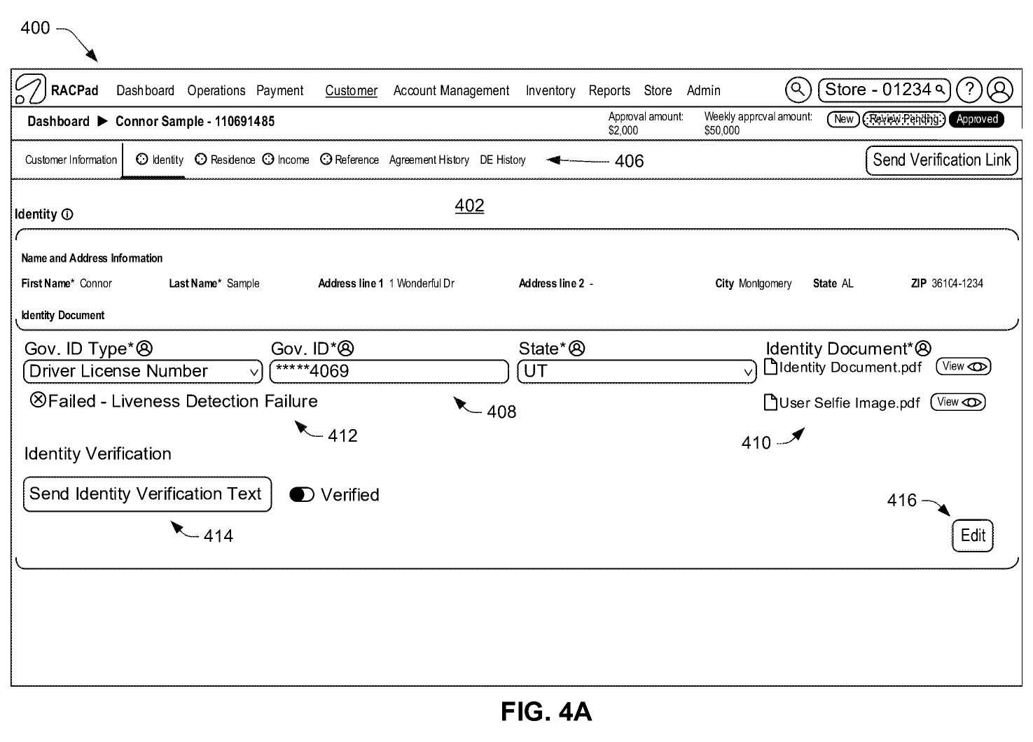

Store Quick Response (QR) code generation/link sending interface view 211 of FIG. 2C illustrates an example store QR code generation/link sending interface of the point-of-sale system, e.g., to a retailer client device, such as second client device 108 of FIG. 1A. Store QR code generation/link sending interface view 211 can be accessed, for example, by clicking the menu option for Send Digital Order Form 210 in FIG. 2B. Store QR code generation/link sending interface view 208 can include a store QR code generation/link sending micro-application 212. Upon entry of a phone number and/or an email address of a customer into corresponding entry fields of the store QR code generation/link sending micro-application 212, the retailer agent or employee can activate one of the button controls indicated at 213, such as the “Generate Store QR” button or the “Send” button in FIG. 2C. The “Generate Store QR” button can trigger the store QR code generation/link sending micro-application 212 to generate and render a QR code on a display screen of the device accessing the point-of-sale system (e.g., second client device 108 of FIG. 1A), which a customer may capture using a camera of another device (e.g., third client device 114 of FIG. 1A) to be directed to a signup/login to the point-of-sale system or an identity verification. The “Send” button can trigger the store QR code generation/link sending micro-application 212 to generate and send a link via text message and/or email to one or both of the entered phone number/email address, which the customer may follow using another device (e.g., third client device 114 of FIG. 1A) to be directed to a signup/login to the point-of-sale system. An example such text message is illustrated in FIG. 3A and will be described in greater detail below.

The point-of-sale system can be used by a retailer user or administrator user, having the appropriate edit access permissions, to insert, update, and/or remove pricing information for leasable retail products tracked within the point-of-sale system. The pricing information can include price (in units of current, such as U.S. dollars), same-as-cash (SAC) days, early purchase option (EPO) percent, and clearance status.

Example operations menu interface view 214 of FIG. 2D shows an Operations drop-down menu accessible by clicking or hovering on the Operations menu option 215. Clicking on the Pricing option 216 within the drop-down menu can lead to a pricing details interface view 217, as shown in FIG. 2E, which can include a pricing details filter micro-application 218. Pricing details filter micro-application 218 can include various data filter fields including Zone, Department, Sub Department, Bracket, Retail Management System (RMS) Number, Brand, Model Number, Type, and Category fields, some of which may be limited lists and thus represented by drop-down entry controls. A “zone” can represent a collection of retail stores and can be organized by geographic region or legal or regulatory jurisdiction region, as examples, where item pricing might differ from zone to zone. In the illustrated example of FIG. 2E, the Zone field 219 has been entered by choosing “2000” from a corresponding drop-down list, and, separately, the Department field 220 has been entered by choosing “COMPUTERS” from a different corresponding drop-down list. A user can apply the pricing details filtering by clicking the Apply button 221 in the pricing details filter micro-application 218. Aspects of the pricing details filter micro-application 218 can be interactive. For example, the Sub Department input field can be disabled until the Department field has received entry, and a Bracket input field can be disabled until the Sub Department input field has received entry.

Clicking the Apply button 221 shown in the example pricing details interface view 217 of FIG. 2E can lead to an updated pricing details interface view 222, as shown in the example of FIG. 2F, that shows pricing data records arranged in scrollable, paginated table form. Each pricing record can correspond to a class of retail item, or so-called stock keeping unit (SKU). Clearance items in the presented pricing table can be indicated with a clearance icon 223 next to an associated pricing record. Records in the presented pricing table can be sorted by column, e.g., by clicking on a column header. In the illustrated example, pricing data records are sorted by department, in ascending alphanumeric order, as indicated by the upward-facing arrow 224. Different pages of the pricing table can be accessed via page controls 225. FIG. 2G shows a scrolled pricing details interface view 226 accessed, from and relative to the updated pricing details interface view 222 of FIG. 2F, by adjusting the horizontal scroll control 227, to view different columns of the pricing data records. The different columns can include SAC Days, SAC Days Printed, and EPO Percentage 228. Details not available for an RMS item are indicated in the table by a hyphen character (“-”).

Example refiltered pricing details interface view 229 of FIG. 2H shows that clicking on the Filter button 230 can provide the filter controls of the pricing details filter micro-application 218, as shown in FIG. 2E, within the pricing details interface view to adjust or refine the filtering of the displayed pricing data. For example, a sub department of “LAPTOPS” can be entered in the Sub Department field 231, the Apply button 232 can be pressed, and the updated filtered results will be shown within the pricing details display micro-application 234.

It may be desired to view the RMS items with incomplete pricing across all zones. As shown in example refiltered pricing details interface view 236 of FIG. 2I, based on there being at least one RMS item with incomplete pricing, a missing price alert button 238 can be displayed in the user interface. The overall missing price alert button 238 can be clicked on to display dialog 240 that includes a Download Report hyperlink. Clicking on the Download Report hyperlink can initiate a download of an overall missing price spreadsheet 244 as shown in FIG. 2J.

FIG. 2J is an illustration of an example spreadsheet 244 used in conjunction with the point-of-sale system for which various views are illustrated in FIGS. 2A-2I and 2K-2T. Although in the illustrated example, spreadsheet 244 is an overall missing price spreadsheet, a spreadsheet of similar form (e.g., with same or similar data columns) can be used for various other functions within the point-of-sale system, such as to enter and upload pricing for new retail products. Spreadsheet 244 can be edited using a spreadsheet application, such as Microsoft Excel or Google Sheets, and uploaded to the point-of-sale system as described in greater detail below, in order to update pricing or complete missing pricing, as examples.

The point-of-sale system can be used to update prices for individual retail products as records in the system. As shown in refiltered pricing details interface view 246 of FIG. 2K, to update the pricing for an individual item, record selection checkbox 248 can be checked to select a specific record and Update button 250 can be clicked on. As shown in refiltered pricing details interface view 252 of FIG. 2L, this can display an Update Pricing dialog 254 by which pricing details can be manually edited in data fields 256. As examples, the user can update the pricing with partial or complete pricing parameters. As examples, for temporary or permanent pricing types, the user can update pricing details in such combinations as Weekly Rate New, Weekly Rate Used, or Term; Cash Price Factor or Forced Cash Price; Add-On Rate; SAC Days or SAC Days Printed; EPO Percentage, and Clearance. For the manual pricing type (not shown in FIG. 2L), the user can update pricing details in such combinations as Weekly Rate New, Weekly Rate Used, or Term; Cash Price Factor or Forced Cash Price; Manual PO Turns; SAC Days or SAC Days Printed; EPO Percentage; and Clearance. As shown by pricing update timing radio button control 257, updates to pricing details as made in data fields 256 can be instituted immediately or overnight. Selecting “Immediately” in the pricing update timing radio button control 257 will update the inventory pricing immediately in the pricing database and will be reflected in the point-of-sale system immediately, whereas selecting “Overnight” in the pricing update timing radio button control 257 will update the inventory pricing overnight (e.g., during non-business hours) and will be displayed in the point-of-sale system starting the next day.

Clicking the Next button 258 in Update Pricing dialog 254 can lead to the example refiltered pricing details interface view 260 of FIG. 2M, which displays approval dialog 262, indicating that the pricing update request has been submitted. Clicking on the No button in the approval dialog 262, e.g., if an agent or employee with pricing update approval permissions (an “approver”) is not immediately available in person, can dismiss the approval dialog 262, leaving the approval to be performed later, e.g., when an approver can access the point-of-sale system. Clicking on the Yes button in the approval dialog dismisses the dialog and advances to refiltered pricing details interface view 264 of FIG. 2N, which displays personal identification number (PIN) entry dialog 266, whereby an approver can enter a PIN and click on Continue button. A success dialog (not shown) indicating that “Request has been approved” may appear to indicate the success of the price update operation and its supervisory approval. An OK button in the success dialog may be clicked to exit the success dialog.

The point-of-sale system can be used to create new pricing. Clicking on the New Pricing button 267, as shown in example refiltered pricing details interface view 264 of FIG. 2N and other views described above, can display a New Pricing dialog (not shown), which can be similar to the Update Pricing dialog 254 shown in FIG. 2L, but with additional data fields for Zone, Department, Sub Department, Bracket, and RMS Number. The user can provide partial or complete pricing parameters while inserting the pricing. As examples, for temporary or permanent pricing types, the user can insert pricing details in such combinations as Weekly Rate New, Weekly Rate Used, or Term; Cash Price Factor or Forced Cash Price; Add-On Rate; SAC Days or SAC Days Printed; EPO Percentage, and Clearance. For the manual pricing type (not shown in FIG. 2L), the user can insert pricing details in such combinations as Weekly Rate New, Weekly Rate Used, or Term; Cash Price Factor or Forced Cash Price; Manual PO Turns; SAC Days or SAC Days Printed; EPO Percentage; and Clearance. Using a pricing insert timing radio button control (not shown), insertions to pricing details as made in the New Pricing dialog data fields can be instituted immediately or overnight. Selecting “Immediately” in the pricing insert timing radio button control will insert the inventory pricing immediately in the pricing database and will be reflected in the point-of-sale system immediately, whereas selecting “Overnight” in the pricing insert timing radio button control will insert the inventory pricing overnight (e.g., during non-business hours) and will be displayed in the point-of-sale system starting the next day.

Clicking a Next button (not shown) in the Insert Pricing dialog (not shown) can lead to an approval dialog, similar to approval dialog 262 shown in FIG. 2M, indicating that the pricing insert request has been submitted and asking if the user would like to continue for approval. The user electing to continue for approval can display a PIN entry dialog similar to PIN entry dialog 266 shown in FIG. 2N and, upon successful PIN entry, a success dialog (not shown) indicating that the pricing insert request has been submitted.

FIG. 2O illustrates an example pricing queue interface view 269, which executes a pricing queue micro-application 270. Pricing queue interface view 269 can be accessed within the point-of-sale system by, for example, choosing Pricing Queue 268 from within the Operations drop-down menu shown in FIG. 2D. Click on Pricing hyperlink 271 in the Type column for a record with Waiting for Approval status can lead to pricing queue interface view 272 of FIG. 2P, which can display Pricing Approval dialog 274 for the chosen record. Updated or inserted SAC Days, SAC Days Printed, and EPO Percentage data fields 276 are displayed in the Pricing Approval dialog 274. Entry of comments into the Comments data field can be optional to approve the pricing but mandatory to reject the pricing. Clicking on Approve button 278 can result in a confirmation dialog (not shown) that can include a message such as “Do you want to approve pricing?” Clicking on Yes button in the confirmation dialog (not shown) can result in a success dialog (not shown) that can provide a message such as “Request has been approved.” Clicking on an OK button (not shown) can dismiss the success dialog.

With reference again to FIG. 2O, a Download button 279 can be clicked to export pricing details for an item to a spreadsheet downloaded to the client device. The Download button will be enabled for pricing approval records having a Failed, Verification in-progress, or Completed status, and disabled for records having Waiting for Approval status.

The point-of-sale system may also be used to upload, to a pricing database associated with the point-of-sale system, pricing information entered into or stored in a spreadsheet. FIG. 2Q shows an example pricing uploads interface view 281 having an Upload Files button 282. Pricing uploads interface view 281 can be accessed, for example, by hovering over or clicking on Operations menu option 215 to display the Operations drop-down menu and clicking on Pricing Uploads 280, as shown in FIG. 2D. Pricing uploads interface view 281 executes a Pricing Uploads micro-application, with which a user can upload a pricing spreadsheet and can verify the uploaded pricing.

Clicking on the Upload Files button 282 can display an Upload File dialog 284, as shown in example pricing uploads interface view 283 of FIG. 2R. Type radio button controls 285 can be used to select the type of upload, whether Pricing, Package, or Zone. Sub Type checkbox controls are also available, to permit sub types of StoreZone, Pricing, or Autoterm. Clicking on the “Download Template” hyperlink 286 can initiate downloading of a spreadsheet template, which can have, for example, the columnar form of spreadsheet 244 shown in FIG. 2J. The desired Pricing can be inserted into the downloaded spreadsheet template, or another spreadsheet can be edited or modified to include the desired pricing. Upload button 287 can be clicked on to bring up a dialog or selection screen from which the spreadsheet to be uploaded can be chosen, or (with operating system and web browser support) a spreadsheet file for upload can be dragged and dropped unto Upload button 287 to upload the spreadsheet file. Save button 288 can be clicked on once the file is uploaded. Upon clicking Save button 288, a loader dialog (not shown) can be displayed. At this point, validations will be performed on the uploaded file. If any corrections need to be made, the pricing uploads micro-application can reject the uploaded spreadsheet and display a Validation Failed dialog (not shown). In the event that corrections need to be made, the user can download the faulty spreadsheet file from Pricing Uploads table (as shown in FIG. 2Q) to view required corrections. After making required corrections in the spreadsheet file, the spreadsheet file can be uploaded again. Clicking on an OK button (not shown) in a Your File is Being Uploaded dialog (not shown), which is displayed only if there are no corrections required in the uploaded spreadsheet file, dismisses the Your File is Being Uploaded dialog.

FIG. 2S shows an example pricing reports interface view 290, which includes a Reports micro-application 291 that can be used to view and generate pricing reports and overall missing reports. Pricing reports interface view 290 can be accessed, for example, by hovering over or clicking on Operations menu option 215 to display the Operations drop-down menu and clicking on Reports 289, as shown in FIG. 2D. Clicking on Generate New Report button 292 can lead to example pricing reports interface view 293 of FIG. 2T, which displays Generate New Report dialog 294. A required report type can be selected from the Type dropdown control 295. Types can include Autoterm, Package, Pricing, and Overall Missing Price. The Pricing type can be selected to generate a Pricing report. The Overall Missing Price type can be selected to generate a Missing Price report. A report zone can be selected from Zone dropdown control 296. The report can be generated for download using the Generate button 297, which can result in display of a success dialog (not shown) having a message such as “Your report is being generated” and an OK button (not shown). The generated report will be displayed in the table of the reports micro-application 291 as shown in FIG. 2S, where the report can be downloaded. The status of the report as shown in the table may initially be “Pending” or “Generating” for the report. Once the status updates to “Completed” for the report, the report can be downloaded by clicking on the Download button associated with the report. The report can, for example, be of the form of a spreadsheet similar to (e.g., having the same data columns as) spreadsheet 244 shown in FIG. 2J.

FIG. 3A-3N illustrate user interface views of a user device, such as third client device 114 of FIG. 1A, used to verify a user for lease-to-own of merchandise. FIGS. 3B-3N are illustrations of example user interface views of a point-of-sale system for facilitating retail transaction workflows, and specifically customer verification workflows, as presented to a customer user, according to an embodiment.

FIG. 3A illustrates an example text messaging user interface 300 displayed on a customer mobile device. Text messaging user interface 300 displays text message 301 containing a hyperlink to a website for ID authentication. Clicking or pressing on the hyperlink in text message 301 can open the website in a web browser of the mobile device, for example. The hyperlink can be have been sent to the customer mobile device by using store QR code generation/link sending micro-application 212 shown in FIG. 2C, for example.

FIG. 3B shows an example web browser interface view 302 of a verification webpage of a point-of-sale system as accessed by a customer client device by clicking or pressing on the hyperlink in text message 301, for example, or by following a URL provided from a generated QR code, as described above with regard to FIG. 2C. The verification webpage of the point-of-sale system can be generated, for example, by a customer verification micro-application. Customers shopping online who submit a reservation web lead (including product and payment), who complete a full online checkout, or who are sent a link by an agent or an employee of the retailer can submit customer verification requirements that can be based on the customer’s lease-to-own approval decision. To complete ID verification, the customer can select the Start button 303 of the verification webpage to initiate the upload process for the customer’s selected ID type.

FIG. 3C shows an example ID scan interface 304 that can use a camera of the customer mobile device to scan a government-issued ID card. The customer can scan the front and back of the government ID card. Upon scanning the ID card, the scan(s) of the ID card can be displayed, e.g., by scan interface 306 of FIG. 3D, which permits the customer to confirm the clarity of the scanned image(s).

Customers may further be requested to submit a self image (“selfie”) to verify their government ID. FIG. 3E shows an example selfie consent form 308 displayed on the customer mobile device. Upon clicking a continue button, the customer mobile device displays a selfie camera interface view 310. The customer can position the customer’s face in the frame of the selfie camera interface view 310 to take a selfie, which the verification micro-application can transmit for verification, which may be automated using facial recognition technology or performed by a human reviewer, to ensure that the customer using the verification process is the person presented in the scanned ID card. Once validation is complete, the customer mobile device displays an ID submission message in government ID submitted interface view 312 of FIG. 3G. The customer can move on to submit additional verification documents by clicking the Next button in government ID submitted interface view 312. In the verification steps that follow, the customer may be prompted to provide additional verification documents based on their approval level recognized by a digital order form (not shown). For example, a Level 1 approval level customer may be required to upload only government ID and proof of residence; a Level 2 approval level customer may be required to upload government ID, proof of residence, and source of income; and a Level 3 approval level customer may be required to upload government ID with selfie, proof of residence, source of income, and contact information for one to two references.

FIG. 3H shows a first residence verification interface view 314 as may be displayed on a web browser of a customer mobile device or other customer device. First residence verification interface view 314 can be displayed automatically after government ID submitted interface view 312 of FIG. 3G, upon pressing the Next button displayed therein. Camera or upload form 316 can be used to submit an accepted proof of residence document (e.g., utility bill, internet bill, government letter), e.g., as a photo taken of a verification document with a camera of the customer device, or as a document file of the verification document. Alternatively, in some embodiments, the customer can enter residence details manually using the provided hyperlink 317.

FIG. 3I shows a second residence verification interface view 318, indicating that a proof of residence document 320 (or picture thereof) has been uploaded. If no additional information is required (e.g., based on the customer falling under Level 1 criteria), the customer can click a Save button (not shown) to complete the process. If the customer must provide additional information (e.g., based on the customer falling under Level 2 or Level 3 criteria), the customer can click the Save and Continue button 321 to move onto the next step.

FIG. 3J shows an income verification interface view 322 as may be displayed on a web browser of a customer mobile device or other customer device. Income verification interface view 322 can be displayed automatically after second residence verification interface view 318 of FIG. 3I, upon pressing the Save & Continue button 321 displayed therein. The customer can verify income by uploading a proof of income document (e.g., recent pay stub, bank statement, Social Security benefits statement) for verification by either by taking a photo of the document with a camera of the customer device or by selecting a file saved on the customer device. If no additional information is required, the customer can click a Save button (not shown) to complete the process. If the customer must provide additional information, the customer can click a Save and Continue button 325 to move onto the next step.

FIG. 3K shows a first reference verification interface view 326 as may be displayed on a web browser of a customer mobile device or other customer device. First reference verification interface view 326 can be displayed automatically after income verification interface view 322 of FIG. 3J, upon pressing the Save & Continue button 325 displayed therein. In first reference verification interface view 326, the customer can select one family member or two non-family members to list as references. The customer can provide the relationship, name, and a phone number for each reference in form 328. FIG. 3L shows a second reference verification interface view 330 as may be displayed on a web browser of a customer mobile device or other customer device. As indicated in second reference verification interface view 330, when a relationship of “friend” is selected for the first reference in Relationship field 332, the form 328 automatically expands to include second reference fields 334. The customer can click the Save and Continue button 329 to move onto the next step.

FIG. 3M shows an information review interface view 336 as may be displayed on a web browser of a customer mobile device or other customer device. First reference verification interface view 326 can be displayed automatically after completing the verification steps, as described above, required of the customer, e.g., upon pressing the Save & Continue button 329, or earlier if fewer verification steps are required of the customer. The customer can use information review interface view 336 to review their verification submissions and click the Acknowledgement box 339 to certify that the provided information is accurate. Once the customer submits the verification requirements, the customer device web browser will be directed to a verification submission completion interface view 340 of FIG. 3N, which can display submission complete message 342.

The submitted verification materials can be made visible in the point-of-sale system (e.g., as displayed by Store Action Items micro-application 206 in FIG. 2A) for an agent or employee of the retailer to verify. For example, the retailer agent or employee may use one or more identify verification micro-applications, as may be accessible from the Customer option within menu 201, to perform the customer information verification.

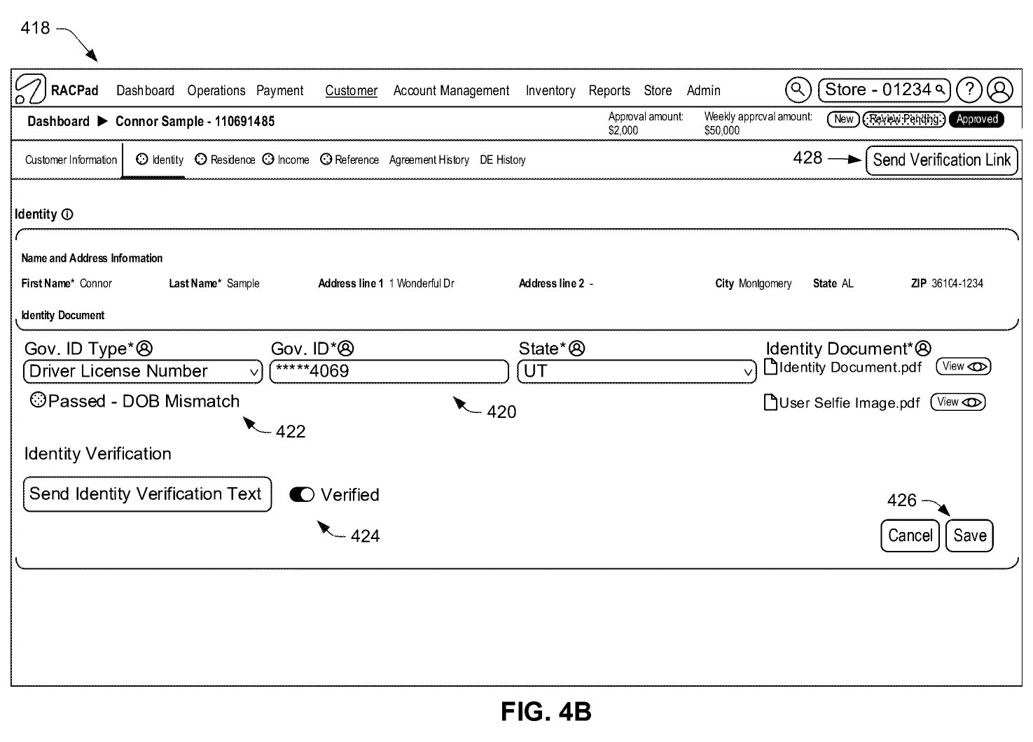

FIGS. 4A and 4B illustrate user interface views of a user device, such as second client device 108 of FIG. 1A, used to verify a user for lease-to-own of merchandise. FIG. 4A and 4B are illustrations of example user interface views of a point-of-sale system for facilitating retail transaction workflows, and specifically customer verification workflows, as presented to a retailer user, according to an embodiment. For example, after a customer has viewed and completed customer verification data entry and/or document uploads as illustrated in FIGS. 3B-3N, a retailer user may use the user interface views illustrated in FIGS. 4A and 4B to confirm the information of the customer user and thereby activate user account permissions and functions of the corresponding customer user account.

FIG. 4A shows an example first customer identity verification interface view 400 as may be displayed on a retailer device. First customer information verification interface view 400 can include a customer identity verification micro-application 402 having customer data displays, links, and controls useful for verification of customer-submitted identity information and documents by an employee or agent of a retailer. Customer identity verification interface view 400 of FIG. 4A can be accessed, for example, from a link in a store action item notification in the point-of-sale system dashboard view, such as store action item notification 404 in FIG. 2A. The retailer agent or employee can select the action item notification to navigate to the customer record as shown in the customer identity verification micro-application 402 and complete verification.

First customer identity verification interface view 400 can include different information tabs 406 that can be clicked on to review identity, residence, income, and reference information. First customer identity verification interface view 400 as illustrated in FIG. 4 shows the Identity tab activated as an example. For the Identity tab in first customer identity verification interface view 400, customer identity verification micro-application 402 shows non-editable identification data fields 408, identity document links 410, and automated identity verification status indicator 412. If identity information is missing, the retailer user can click a Send Identity Verification Text button 414 to send or re-send an identity verification text message, like text message 301 shown in FIG. 3A, to the customer. Automated identity verification status indicator 412 can show the status of an automated identity verification as may be provided by a third-party vendor, which can automatically mark a customer as verified.

Based on the status shown in automated identity verification status indicator 412 returning as failed or passed with flag, then the retailer user can review the flag and other submitted information to manually verify the customer identification. Clicking the identity document links 410 allows the retailer user to manually review customer-submitted documents, such as those submitted using the process illustrated in FIGS. 3C-3G (or 3H-3L under other tabs 406). Clicking the Edit button 416 makes identification data fields 408 editable, as shown in FIG. 4B.

FIG. 4B shows an example second customer identity verification interface view 418 as may be displayed on a retailer device. In second customer identity verification interface view 418, identification data fields 420 have become editable. Second customer identity verification interface view 418 also shows a different example automated identity verification status indicator 422, in which an automated check passed the identification verification but noted a date-of-birth mismatch. After reviewing and/or editing the customer identification data under the Identity tab, the retailer user can activate verification toggle control 424 to mark the identity information as manually verified and/or click the save button 426 to save any manually edited identify information in identification data fields 420. The verification process can be repeated for all required tabs in the customer record. The tabs that may require retailer user verification can be based on the customer’s approval level, as described above. The customer verification micro-application which renders customer verification webpages, as shown in FIGS. 3B-3N, can recognize the customer’s approval level based on existing information and/or documents and only request missing requirements from the customer. Based on a customer has placed an order but has not uploaded the materials required for their verification level or completed identification verification, the retailer user can send or resend the link to collect this information by clicking the Send Verification Link button 428, which sends a verification link (e.g., link in text message 301 in FIG. 3A) to the customer phone number and/or email.

Thus, the identity verification micro-application may be functional to send the customer an email or text message to alert the customer to cure faulty verification information or documents that do not pass automated, semi-automated, or manual reviews, e.g., by re-uploading the documents or uploading different documents. The customer may do so, for example, by repeating one or more portions of the process described above with regard to FIGS. 3A-3N.

### Communications Between Micro-Applications

Session management and serverless technology can be used to implement communication between micro-applications assembled together within a point-of-sale system user interface as rendered on a client device. One micro-application can provide data to another micro-application within one or more session variables that can persist from view to view within the functioning of the point-of-sale system user interface. Asynchronous data transfer between micro-applications can be performed, for example, by a micro-application posting an event to a message topic. The event can include data to be transferred to another micro-application, stored in a backend data store, or that should be processed in some way before the transfer or storage. The event can be subsequently picked up by a subscriber queue, which, in turn, can trigger a cloud-based function-as-a-service to perform some work on the data. The data can then be made available to a micro-application that pulls the data, or a micro-application to which the data is pushed.

In some embodiments, a parent micro-application (e.g., a menu) can be provided within a point-of-sale system user interface view to serve in part as a communication backbone between and among other micro-applications within the point-of-sale user interface view. For example, each other micro-application retrieved, executed, and rendered for display within the point-of-sale system user interface view can be a child micro-application to the parent micro-application, and can transmit one or more messages, which may be addressed to another micro-application within the point-of-sale system user interface view, to the parent micro-application. The parent micro-application can forward on the one or more messages to the appropriate addressee micro-application. Such a communications backbone architecture has technical benefits and advantages of simplifying communications between micro-applications, e.g., by not needing to provide a multiplicity of individual inter-micro-application communication protocols.

### Automatic Pricing Adjustment End-to-End Flow

In addition to enabling manual price updates and insertions, as described above, a point-of-sale system as described herein may perform automatic pricing revisions or adjustments on retail products in inventory in accordance with various data, rules, trends, and formulas, among other price determinants. The automatic pricing adjustments can be performed, for example, by an ensemble of interconnected cloud-based software services working collectively to manage, compute, store, and retrieve pricing data.

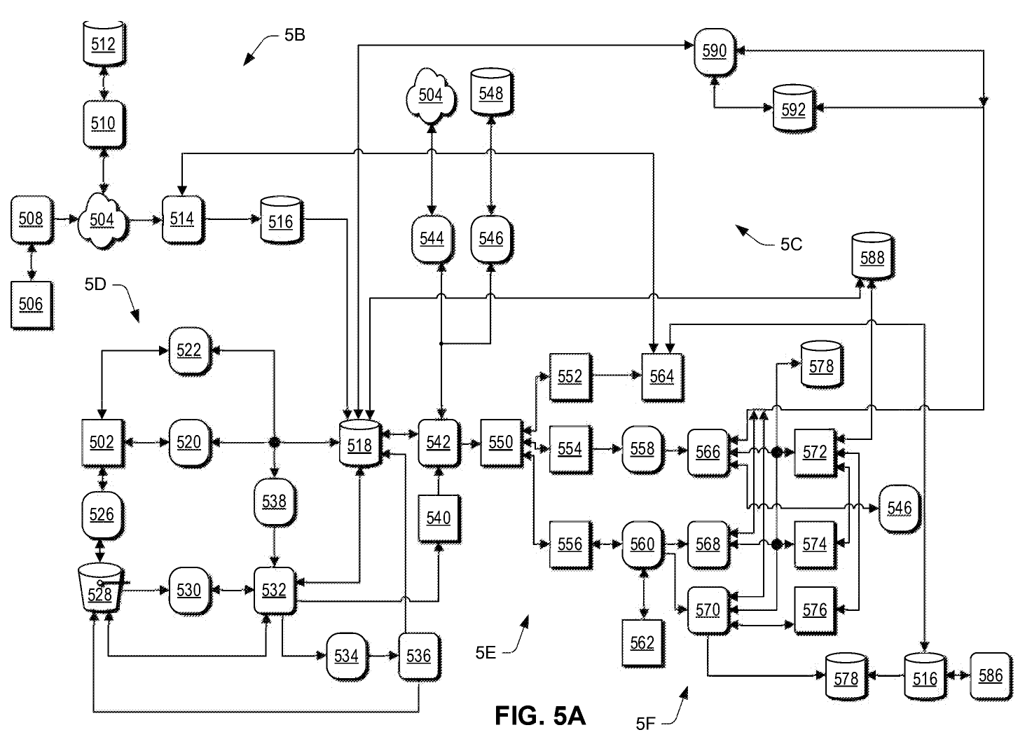

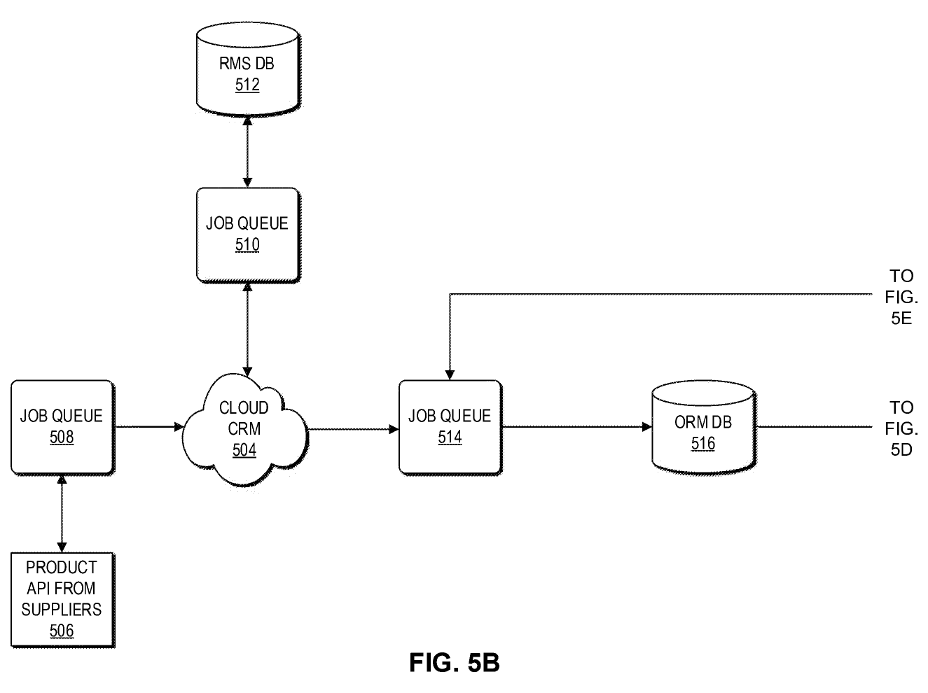

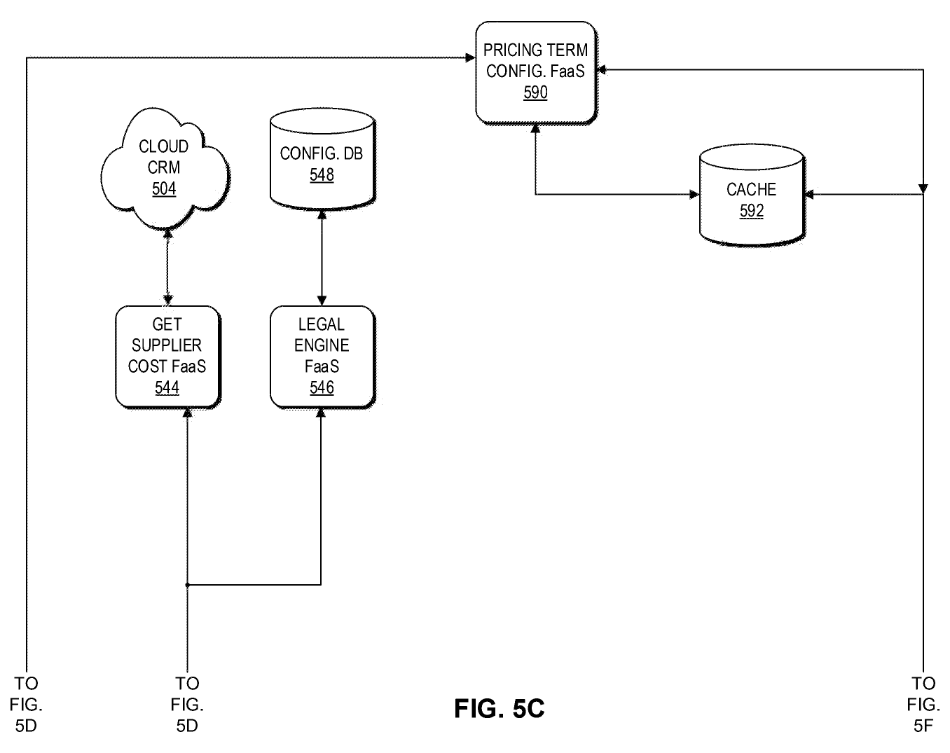

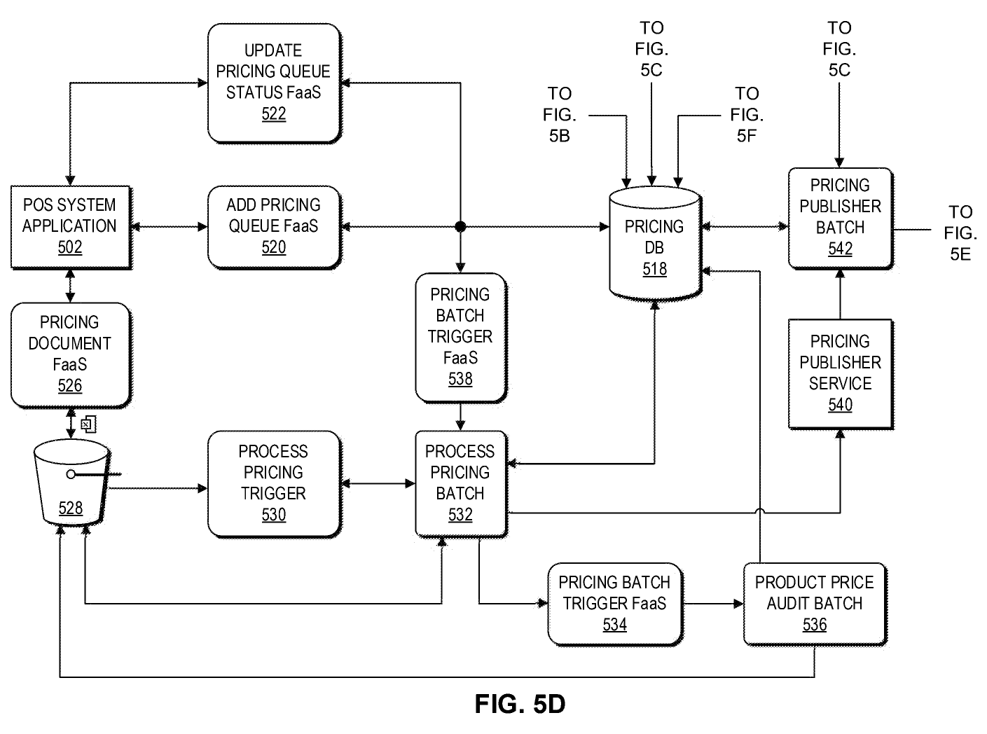

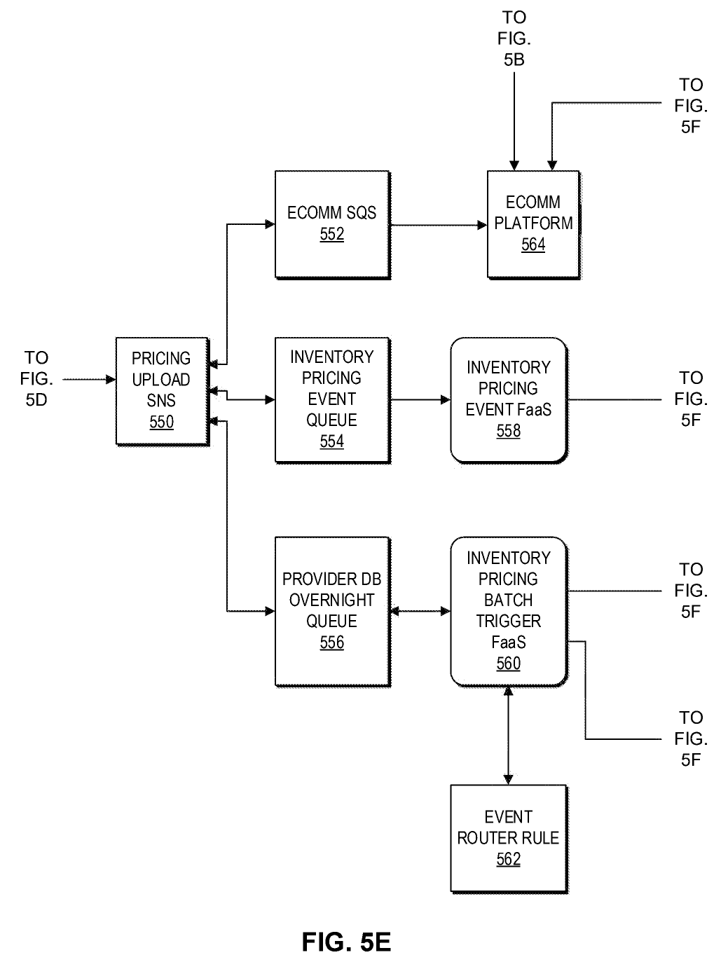

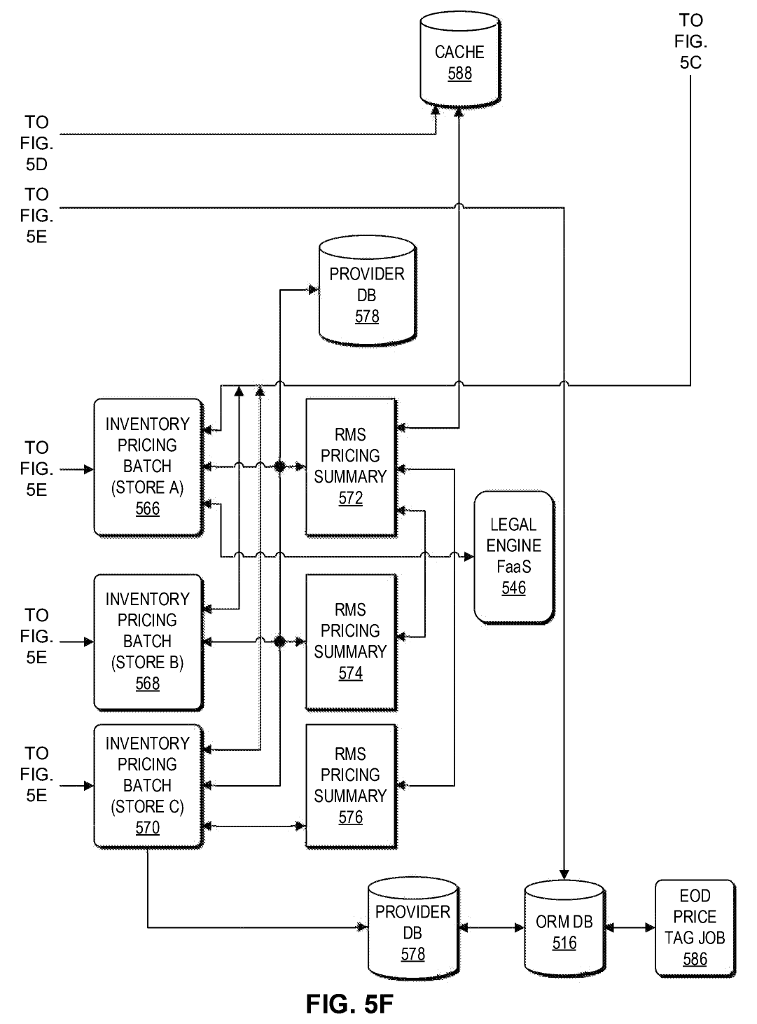

FIGS. 5A-5F illustrate a system flowchart showing an example pricing services ensemble for automatically updating pricing of retail products, as may be viewable and editable in a point-of-sale system, according to some embodiments. The flowchart of FIGS. 5A-5F can be performed by processing logic that can comprise hardware (e.g., circuitry, dedicated logic, programmable logic, microcode, etc.), software (e.g., instructions executing on a processing device), or a combination thereof. For example, the flowchart of FIGS. 5A-5F can be performed by serverless services such as functions-as-a-service and job queue services.

As a non-limiting example of FIG. 1A, one or more functions described with respect to FIGS. 5A-5F may be performed by a one or more components of system 100 (e.g., point-of-sale system server 126 and first cloud-based micro-applications server 122 through Nth cloud-based micro-applications server 124). In such an embodiment, any of these components may execute code in memory to perform certain steps of the flowchart of FIGS. 5A-5F. Other components (e.g., other cloud-based servers) may store the code and therefore may execute the flowchart of FIGS. 5A-5F. Moreover, it is to be appreciated that not all steps may be needed to perform the disclosure provided herein. Further, some of the functions may be performed simultaneously, in a different order, or by the same components than shown in FIGS. 5A-5F, as will be understood by a person of ordinary skill in the art.

FIG. 5A provides an overview of the illustrated example services ensemble, and FIGS. 5B-5F show portions of the example services ensemble illustrated in FIG. 5A. Elements of FIGS. 5B-5D are illustrative embodiments of corresponding elements of FIG. 5A. Elements illustrated in FIGS. 5A-5F can each fall into one of a variety of categories, as described below.

Elements 520, 522, 526, 530, 534, 538, 544, 546, 590, 558, and 560 each represents an instance of an event-driven, serverless function as a service (FaaS). Each FaaS is configured to run code without provisioning or managing servers, to execute the code, or one or more portions of the code, in response to one or more events, and to automatically manage the computing resources required by the executed code. By “serverless,” it is meant that the FaaS is provided by a virtualized computing cloud service in which different cloud capability types can be used without having to expressly provision, deploy, and manage either hardware or software resources to support the cloud capability types, apart from providing application code or data. Examples of FaaS providers include Amazon Web Services Lambda (AWS Lambda), Cloudflare Workers, Fn Project, Genezio Functions, Google Cloud Functions, Iron.io IronFunctions, Knative, Microsoft Azure Functions, Netlify Functions, OpenFaaS, Twilio Functions, and Vercel Functions. Legal engine FaaS 546 is shown twice in FIG. 5A for ease of illustration.

Elements 508, 510, 514, 532, 536, 542, 566, 568, and 570 each represent an instance of a job queue batch computing service. Each job queue batch computing service is configured to receive and manage large numbers of independent jobs, automatically scaling compute resources as needed to execute them efficiently on cloud computing resources, without requiring manual management of the underlying infrastructure. Each job queue batch computing service can run batch workloads on the cloud and can handle the complexities of provisioning, scaling, and de-provisioning computing resources (e.g., virtualized server instances or clusters) based on the needs of the jobs submitted to the job queue batch computing service. Each job queue batch computing service can manage scheduling and execution of submitted jobs based on their priorities and resource requirements. Examples of a job queue batch computing service include Amazon Web Services Batch (AWS Batch), Apache Airflow, Microsoft Azure Batch, IBM Workload Automation, and Prefect.

Elements 540, 572, 574, and 576 each represents an instance of an application programming interface gateway (API gateway) service. An API gateway service is configured as a central entry point for applications to access backend services, handling tasks like traffic management, authorization, and security. Examples of an API gateway service include Amazon API Gateway, Apigee API Management, Axway Amplify API Management, IBM API Connect, Kong Gateway, Microsoft Azure API Management, MuleSoft Anypoint Platform, Postman API Platform, and WSO2 API Manager.

Element 550 represents an instance of an application-to-application (A2A) push notification service. A push notification service is a managed service that facilitates sending notifications from the cloud to devices and queue services, to deliver messages. Examples of a push notification service include Amazon Simple Notification Service (SNS), Google Cloud Pub/Sub, Microsoft Azure Service Bus, and event brokers like Apache Kafka and RabbitMQ.

Elements 552, 554, and 556 each represent an instance of a message queue service. A message queue service is a fully managed message queuing service that decouples and scales micro-services, distributed systems, and serverless applications by allowing them to send, store, and retrieve messages asynchronously, improving scalability and resilience. Examples of a message queue service include Amazon Simple Queue Service (SQS), Apache ActiveMQ, IronMQ, RabbitMQ, IBM MQ, WebSphere MQ, and ZeroMQ.

Element 564 represents an instance of an ecommerce platform, e.g., a third-party shopping website.

Elements 512, 516, 518, 548, 578, and 580 each represents an instance of databases. The databases can be, for example, relational databases, or high-speed non-relational databases, stored in long-term storage. Elements 516 and 564 are instances of an object-relational mapper (ORM) database. An ORM translates data between an object-oriented programming language and a relational database. An example ORM is Ent, an entity framework that can be used to model data in a graph-based structure. Elements 516 and 578 are each shown twice for clarity of illustration. Elements 588 and 592 represent data caches, stored in storage that is higher-speed and shorter term than storage used to store databases.

Element 528 represents an instance of an object store container. An object store container is capable of holding objects (including files and associated metadata) and providing a way to store and retrieve data in a scalable and durable manner. Examples of an object store container include an Amazon Web Services Simple Storage Service (AWS S3) bucket, a Ceph Object Gateway bucket, a Microsoft Azure Blob Storage container, a MinIO bucket, and a Swift container.

Element 562 represents an instance of an event router rule on a serverless event bus or other event routing service. An event router rule defines how events on the event bus are routed to specific targets (such as functions-as-a-service or notification service topics) based on their content or a schedule, acting as a router between events and downstream consumers. Examples of services that provide event router rules include Amazon EventBridge, Azure Event Grid, Google Eventarc, Confluent Kafka, TriggerMesh, and Apache Camel.

Element 504, shown twice in FIG. 5A for convenience of illustration, represents an instance of cloud-based customer relationship management software (cloud CRM), such as Salesforce.

With reference to FIGS. 5A and 5B, products data from product API from suppliers 506 can be pushed to job queue 508 for subsequent transmission to cloud CRM 504. Products data maintained in the cloud CRM 504 can be provided to job queue 510 for storage in RMS database 512, and to job queue 514 for storage in ORM database 516.

With reference to FIGS. 5A and 5C, cloud CRM 504 can maintain the purchase cost of retail products, e.g., based on cost zone, as purchase cost data. Get Supplier Cost FaaS 544 can obtain purchase cost data from cloud CRM 504. Based on the purchase cost data, Get Supplier Cost FaaS 544 can prompt Pricing Publisher Batch job queue batch computing service 542 (shown in FIG. 5D) to publish pricing data. Configuration database 548 can maintain legal engine business rules. Legal Engine FaaS 546 can obtain legal engine business rules from configuration database 548. Based on legal engine business rules, Legal Engine FaaS 546 can prompt Pricing Publisher Batch job queue batch computing service 542 (shown in FIG. 5D) to publish pricing data. Pricing Term Configuration FaaS 590 can fetch the Autoterm discount based on the number of days inventory is rented and can store discount data in cache 592. Pricing Term Configuration FaaS 590 can also read/write to pricing database 518 (shown in FIG. 5D).

With reference to FIGS. 5A and 5D, a point-of-sale system application 502, such as described above (e.g., with reference to FIGS. 2A-2I and 2K-2T), can be used by authorized individuals logged into respective client devices to manually update or insert pricing information, as described above. Point-of-sale system application 502, and the various micro-applications that serve as its constituents, can thus provide updated pricing data to Update Pricing Queue Status FaaS 522 and inserted pricing data to Add Pricing Queue FaaS 520. Based on whether the pricing data was instructed to be updated immediately or queued (e.g., for overnight change), the Update Pricing Queue Status FaaS 522 and the Add Pricing Queue FaaS 520 can either call the pricing database 518 to make the manual pricing data changes immediately, or can queue the pricing data changes using Pricing Batch Trigger FaaS 538. Pricing Batch Trigger FaaS 538 can send pricing data to Process Pricing Batch job queue batch computing service 532, which can manage a scheduled change of data in the pricing database 518. Pricing database 518 can, for example, store pricing data at the zone level.

An employee, agent, or administrator can upload an item-level pricing in a spreadsheet through a micro-application of the point-of-sale system application 502 using methods described above. Pricing Document FaaS 526 can get a token from point-of-sale system application 502 to upload the spreadsheet as pricing data to object store container 528. Process Pricing Batch job queue batch computing service 532 can download the pricing data from object store container 528 and can schedule and perform the pricing data changes ordered in the pricing data in pricing database 518 as a batch job.

Pricing Batch Trigger FaaS 534 can receive a batch pricing data change from Process Pricing Batch job queue batch computing service 532 and can trigger a product price audit batch job. Product Price Audit Batch job queue batch computing service 536 can download and update missing pricing data in a separate spreadsheet and upload the separate spreadsheet to object store container 528.

Pricing data changes as may be made to the pricing database 518 can also be published for receipt by other services or recipients. In receipt of pricing data changes from Product Price Audit Batch job queue batch computing service 532, Pricing Publisher service 540 can trigger a pricing data publication job through an API. Pricing Publisher Batch job queue batch computing service 542 can publish pricing data to various ecommerce platforms (e.g., retail websites) and to the pricing database 518.

With reference to FIGS. 5A and 5E, based on publication jobs from Pricing Publisher Batch job queue batch computing service 542 (shown in FIG. 5D), Pricing Upload SNS 550 can push price data change messages to a variety of message queues, including Ecommerce SQS 552, Inventory Pricing Event Queue 554, and Provider Database Overnight Queue 556. Ecommerce SQS 552 can adjust prices in Ecommerce Shopping Cart 564. Inventory Pricing Event Queue 554 can feed Inventory Pricing Event FaaS 558. Provider Database Overnight Queue 556 can feed Inventory Pricing Batch Trigger FaaS 560. Event Router Rule 562 can control Inventory Pricing Batch Trigger FaaS 560 to pull messages from Provider DV Overnight Queue 556 and trigger each batch for each queue.

With reference to FIGS. 5A and 5F, Inventory Pricing Event FaaS 558 (shown in FIG. 5E) can cause Inventory Pricing Batch job queue batch computing service 566 to process batch pricing changes for store group A (e.g., a first group of 100 stores). These batch pricing changes can happen immediately, as opposed to being queued for later triggered processing, e.g., overnight. Inventory Pricing Batch job queue batch computing service 566 can fetch Autoterm data for inventory already rented from cache 592, which stores the cached value of discounts, to calculate discounted term and cash price. Based on the data not being cached, Inventory Pricing Batch job queue batch computing service 566 can call an API to Pricing Term Configuration FaaS 590 (shown in FIG. 5C) to fetch the Autoterm discount data. Inventory Pricing Batch job queue batch computing service 566 can also access provider database 578 to get stock idle inventories in a store based on the RMS hierarchy value. Inventory Pricing Batch job queue batch computing service 566 can also access Legal Engine FaaS 546 which can process prices using legal engine business rules. Inventory Pricing Batch job queue batch computing service 566 can communicate with RMS Pricing Summary API gateway service 572. RMS Pricing Summary API gateway service 572 can get cached zone level pricing data from cache 588, or, if the zone level pricing data is not cached in cache 588, RMS Pricing Summary API gateway service 572 can get pricing data from pricing database 518 (shown in FIG. 5D).

Inventory Pricing Batch Trigger FaaS 560 (shown in FIG. 5E) can cause Inventory Pricing Batch job queue batch computing service 568 to process batch pricing changes for store group B (e.g., a second group of 100 stores). These batch pricing changes happen when scheduled, e.g., overnight, as opposed to happening immediately. Inventory Pricing Batch job queue batch computing service 568 can fetch Autoterm data for inventory already rented from cache 592, which stores the cached value of discounts, to calculate discounted term and cash price. Based on the data not being cached, Inventory Pricing Batch job queue batch computing service 568 can call an API to Pricing Term Configuration FaaS 590 (shown in FIG. 5C) to fetch the Autoterm discount data. Inventory Pricing Batch job queue batch computing service 568 can also access provider database 578 to get stock idle inventories in a store based on the RMS hierarchy value. Inventory Pricing Batch job queue batch computing service 568 can communicate with RMS Pricing Summary API gateway service 574. RMS Pricing Summary API gateway service 574 can communicate with RMS Pricing Summary API gateway service 572 to fetch price data from pricing database 518 (shown in FIG. 5D).

Inventory Pricing Batch Trigger FaaS 560 (shown in FIG. 5E) can cause Inventory Pricing Batch job queue batch computing service 570 to process batch pricing changes for store group C (e.g., a third group of 100 stores). These batch pricing changes happen when scheduled, e.g., overnight, as opposed to happening immediately. Inventory Pricing Batch job queue batch computing service 570 can fetch Autoterm data for inventory already rented from cache 592, which stores the cached value of discounts, to calculate discounted term and cash price. Based on the data not being cached, Inventory Pricing Batch job queue batch computing service 570 can call an API to Pricing Term Configuration FaaS 590 (shown in FIG. 5C) to fetch the Autoterm discount data. Inventory Pricing Batch job queue batch computing service 570 can also access provider database 578 to get stock idle inventories in a store based on the RMS hierarchy value. Inventory Pricing Batch job queue batch computing service 570 can communicate with RMS Pricing Summary API gateway service 576. RMS Pricing Summary API gateway service 576 can communicate with RMS Pricing Summary API gateway service 572 to fetch price data from pricing database 518 (shown in FIG. 5D).

Inventory Pricing Batch job queue batch computing service 570 can also write in an inventory price table of provider database 578. End-of-Day Price Tag job queue batch computing service 566 can activate the price queued through two-way synchronization between ORM database 516 and provider database 578. Pricing data from ORM database 516 is pushed to the one or more ecommerce platforms 564.

The example pricing services ensemble for automatically updating pricing of retail products, as shown in FIGS. 5A-5F, can collectively to manage, compute, store, and retrieve pricing data to perform automatic pricing revisions or adjustments on retail products in inventory in accordance with various data, rules, trends, and formulas, among other price determinants. The example pricing services ensemble of FIGS. 5A-5F can thus provide technical advantages of automation, speed, and consistency in treatment of pricing over systems that rely on manual retailer user tracking and updating of pricing data.

### Method of Building Instances of a Dynamic Point-of-Sale System User Interface

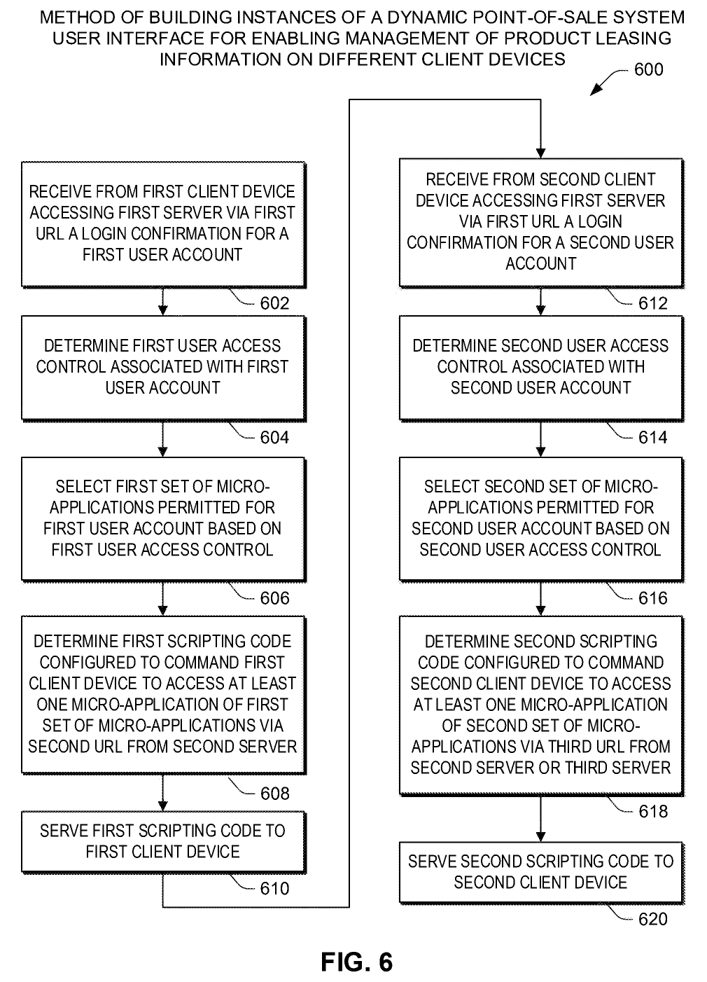

FIG. 6 is a flowchart illustrating a method 600 for building instances of a dynamic point-of-sale system user interface for enabling management of product leasing information on different client devices, according to some embodiments. Method 600 can be performed by processing logic that can comprise hardware (e.g., circuitry, dedicated logic, programmable logic, microcode, etc.), software (e.g., instructions executing on a processing device), or a combination thereof. As a non-limiting example of FIG. 1A, one or more functions described with respect to FIG. 6 may be performed by a one or more components of system 100 (e.g., second client device 108, third client device 114, point-of-sale system server 126, first cloud-based micro-applications server 122, and Nth cloud-based micro-applications server 124). In such an embodiment, any of these components may execute code in memory to perform certain steps of method 600 of FIG. 6. While method 600 of FIG. 6 is discussed below as being performed by certain components of system 600, other components may store the code and therefore may execute method 600 by directly executing the code. Accordingly, the following discussion of method 600 will refer to components of FIG. 1A as illustrative non-limiting embodiments. Moreover, not all steps may be needed to perform the disclosure provided herein. Further, some of the functions may be performed simultaneously or in a different order than shown in FIG. 6.

At step 602, a first server (e.g., point-of-sale system server 126 in FIG. 1A) can receive, from a first client device accessing the first server via a first URL (e.g., second client device 108 in FIG. 1A) a login confirmation for a first user account. For example, the first client device in FIG. 6 can be a retailer client device, such as a personal computer operating in a retail location, or a mobile device assigned to a retailer agent or employee. The login confirmation can be, for example, as described with regard to FIG. 1B. For example, the login confirmation can be an SSO login confirmation, as described above with regard to SSO login confirmation 170 in FIG. 1B. In some embodiments, the login confirmation can be generated by the first server itself, e.g., in examples where the first server retains user login authentication data and verification process code, and performs user login authentication without resort to a third-party authentication provider, such as an SSO provider.

At step 604, the first server can determine a first user access control (e.g., comprising at least one user role or user permissions) associated with the first user account. As one example, the first user account can be a retailer user account and can have one or more associated user roles and/or user permissions specific to the retailer user. Such user roles and/or user permissions may be stored in the first server, e.g., in a data store thereof (not illustrated), such as a database.

At step 606, the first server can select a first set of micro-applications permitted for the first user account based on the first user access control (e.g., comprising at least one user role or user permissions) associated with the first user account. The first set of micro-applications can be selected from a plurality of micro-applications each having a product leasing information management feature, e.g., including at least one of customer verification or inventory price management. As used herein, a “set” of micro-applications can consist of multiple micro-applications or can consist of only one micro-application.

At step 608, the first server can determine first scripting code configured to command the first client device to access at least one micro-application of the first set of micro-applications via a second URL from a second server. In some embodiments, the first server is configured not to directly send, to the first client device, code for executing the at least one micro-application of the first set of micro-applications. Instead, the first server sends only the second URL, from which the first client device may retrieve the at least one micro-application of the first set of micro-applications from a server different from the first server (e.g., one of first cloud-based micro-applications server 122 through Nth cloud-based micro-applications server 124).

At step 610, the first server can serve the first scripting code to the first client device. The first scripting code is configured such that, when executed on the first client device, the first scripting code causes the first client device to assemble a first instance of the dynamic point-of-sale system user interface including the first set of micro-applications. As examples, the first instance of the user interface can be as shown in FIGS. 2A-2I, 2K-2T, 4A or 4B. The first client device can be configured to render and display the first instance of the dynamic point-of-sale system user interface to a display of the first client device.

At step 612, the first server can receive, from a second client device (e.g., third client device 114 in FIG. 1A) accessing the first server via the first URL, a login confirmation for a second user account. The login confirmation can be similar to the login confirmation received from the first client device described above, e.g., an SSO login confirmation. In an example, the second client device in FIG. 6 can be a customer client device, such as a personal computer or a mobile device belonging to a customer (or prospective customer) of the retailer.

At step 614, the first server can determine a second user access control (e.g., comprising at least one user role or user permissions) associated with the second user account. The second user access control is different from the first user access control. For example, the second user account can be a customer user account and can have one or more associated user roles and/or user permissions specific to the customer user. Such user roles and/or user permissions may be stored in the first server, e.g., in a data store thereof (not illustrated), such as a database.

At step 616, the first server can select a second set of micro-applications permitted for the second user account based on the second user access control. The second set of micro-applications can be selected from the plurality of micro-applications. The second set of micro-applications can be different from the first set of micro-applications. As one example, the second set of micro-applications can include a customer information verification micro-application with which the customer user may enter and/or upload customer identity, residence, income, and/or reference information and/or documents. As another example, the second set of micro-applications can include a micro-application by which a customer user may manage purchases, payments, delivery scheduling, or other customer functions associated with lease-to-own transactions within the point-of-sale system.

At step 618, the first server may determine second scripting code configured to command the second client device to access at least one micro-application of the second set of micro-applications via a third URL from the second server or a third server. In some embodiments, the first server is configured not to directly send, to the second client device, code for executing the at least one micro-application of the second set of micro-applications. Instead, the first server sends only the second URL, from which the second client device may retrieve the at least one micro-application of the second set of micro-applications from a server different from the first server (e.g., one of first cloud-based micro-applications server 122 through Nth cloud-based micro-applications server 124).

At step 620, the first server can serve the second scripting code to the second client device. The second scripting code is configured such that, when executed on the second client device, the second scripting code causes the second client device to assemble a second instance of the dynamic point-of-sale system user interface, including the second set of micro-applications. As examples, the second instance of the user interface can be as shown in FIGS. 3B-3N. The second client device can be configured to render and display the second instance of the dynamic point-of-sale system user interface to a display of the second client device.

In embodiments, the first and second instances of the dynamic point-of-sale system user interface may display records corresponding to physical products eligible for a product leasability transaction from physical retail stores or online stores. In such embodiments, the dynamic transaction interface may include separate tabs or interfaces for each physical retail store or online store with specific payment information (e.g., with specific price amounts for each retail store) for the product leasability transactions at or with each of the stores.

By following the steps outlined in method 600, system 100 provides technical improvements to conventional transaction systems by enabling customized user interfaces for inventory and pricing management, customer verification, and transaction of physical products, that are dynamically built client-side based on one or more user access controls of the specific logged-in user.

The steps generally outlined in steps 602 through 610, or in steps 612 through 620, can be repeated for additional client devices (e.g., a third client device, e.g., first client device 102 in FIG. 1A) which may have still other user access controls (e.g., other user roles or user permissions, such as one or more administrative user roles and/or user permissions). For example, such administrative client devices may be provided with one or more URLs for still other micro-applications not accessible by the first and second client devices.

### Computer System

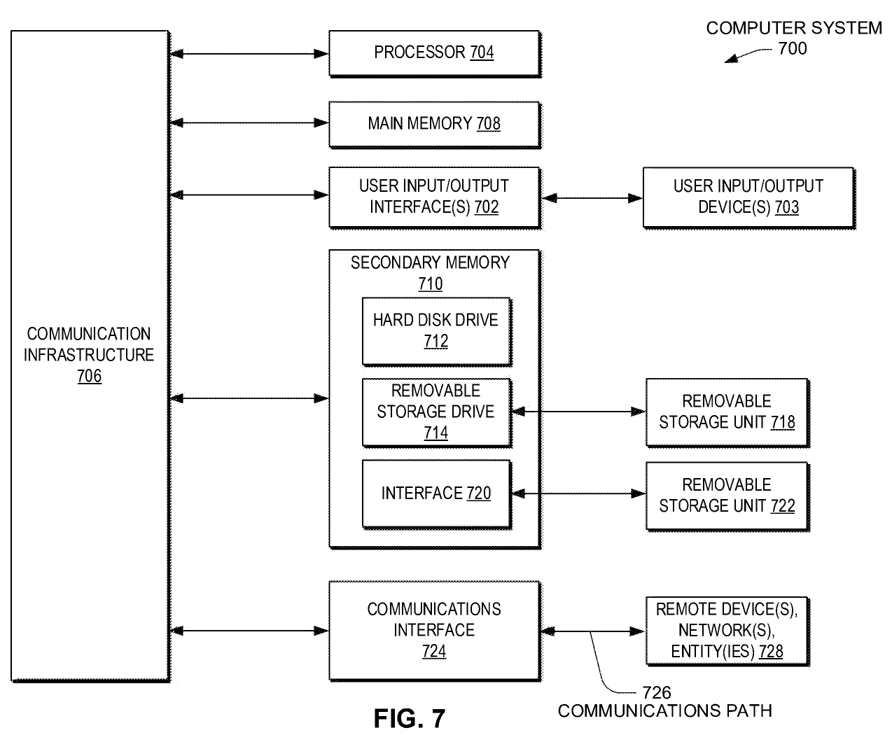

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU) or a neural processing unit (NPU). In an embodiment, a GPU or NPU may be a processor that is a specialized electronic circuit designed to process mathematically intensive applications. The GPU or NPU may have a parallel structure that is efficient for parallel processing of large blocks of data, such as mathematically intensive data common to computer graphics applications, images, videos, artificial intelligence and machine learning, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/ any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all illustrative embodiments as contemplated by the inventor(s), and thus, are not intended to limit this disclosure or the appended claims in any way.

While this disclosure describes illustrative embodiments for illustrative fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described illustrative embodiments, but should be defined only in accordance with the following claims and their equivalents.

What is claimed is:

1. A computer-implemented method for building instances of a dynamic point-of-sale system user interface for enabling management of product leasing information on different client devices, the method comprising:
receiving, by a first server, from a first client device accessing the first server via a first uniform resource locator (URL), a login confirmation for a first user account;
determining a first user access control comprising at least one user role or user permissions associated with the first user account;
selecting a first set of micro-applications permitted for the first user account based on the first user access control, the first set of micro-applications selected from a plurality of micro-applications each having a product leasing information management feature including at least one of customer verification or inventory price management;
determining first scripting code configured to command the first client device to access at least one micro-application of the first set of micro-applications from a second server via a second URL; and
serving, from the first server, the first scripting code to the first client device, wherein the first scripting code, when executed on the first client device, causes the first client device to assemble a first instance of the dynamic point-of-sale system user interface including the first set of micro-applications, and wherein the first client device is configured to render and display the first instance of the dynamic point-of-sale system user interface to a display of the first client device.

2. The method of claim 1, further comprising:
receiving, by the first server, from a second client device accessing the first server via the first URL, a login confirmation for a second user account;
determining a second user access control comprising at least one user role or user permissions associated with the second user account, wherein the second user access control is different from the first user access control;
selecting a second set of micro-applications permitted for the second user account based on the second user access control, the second set of micro-applications selected from the plurality of micro-applications, wherein the second set of micro-applications is different from the first set of micro-applications;
determining second scripting code configured to command the second client device to access at least one micro-application of the second set of micro-applications from the second server or a third server via a third URL; and
serving, from the first server, the second scripting code to the second client device, wherein the second scripting code, when executed on the second client device, causes the second client device to assemble a second instance of the dynamic point-of-sale system user interface including the second set of micro-applications, and wherein the second client device is configured to render and display the second instance of the dynamic point-of-sale system user interface to a display of the second client device.

3. The method of claim 2, wherein the first set of micro-applications comprises an inventory price management micro-application that enables updating or inserting pricing data for retail product records, and the second set of micro-applications comprises a customer verification micro-application that enables inputting or uploading customer verification information and documents.

4. The method of claim 2, further comprising:
receiving, by the first server, from a third client device accessing the first server via the first URL, a login confirmation for a third user account;
determining a third user access control comprising at least one user role or user permissions associated with the third user account, wherein the third user access control is different from the first user access control and different from the second user access control;
selecting a third set of micro-applications permitted for the third user account based on the third user access control, the third set of micro-applications selected from the plurality of micro-applications, wherein the third set of micro-applications is different from the first set of micro-applications and the second set of micro-applications;
determining third scripting code configured to command the third client device to access at least one micro-application of the third set of micro-applications from the second server, the third server, or a fourth server via a fourth URL; and
serving, from the first server, the third scripting code to the third client device, wherein the third scripting code, when executed on the third client device, causes the third client device to assemble a third instance of the dynamic point-of-sale system user interface including the third set of micro-applications, and wherein the third client device is configured to render and display the third instance of the dynamic point-of-sale system user interface to a display of the third client device.

5. The method of claim 4, wherein the first user account is a retailer user account, the second user account is a customer user account, and the third user account is an administrator user account.

6. The method of claim 2, wherein the first instance of the dynamic point-of-sale system user interface comprises a first dashboard showing first inventory and pricing data, the second instance of the dynamic point-of-sale system user interface comprises a second dashboard showing second inventory and pricing data, and wherein the method further comprises:
receiving, by the first client device and the second client device, messages in an event stream, thereby maintaining consistency between the first inventory and pricing data shown on the first dashboard and the second inventory and pricing data shown on the second dashboard.

7. The method of claim 1, wherein:
the first set of micro-applications comprises a parent micro-application, a first child micro-application, and a second child micro-application;
the first child micro-application and the second child micro-application are each configured to communicate with the parent micro-application; and
the first child micro-application and the second child micro-application are each configured to communicate with each other via the parent micro-application.

8. A non-transitory computer-readable device having instructions stored thereon that, when executed by at least one computing device of a first server, cause the at least one computing device to perform operations for building instances of a dynamic point-of-sale system user interface for enabling management of product leasing information on different client devices, the operations comprising:
receiving, from a first client device accessing the first server via a first uniform resource locator (URL), a login confirmation for a first user account;
determining a first user access control comprising at least one user role or user permissions associated with the first user account;
selecting a first set of micro-applications permitted for the first user account based on the first user access control, the first set of micro-applications selected from a plurality of micro-applications each having a product leasing information management feature including at least one of customer verification or inventory price management;
determining first scripting code configured to command the first client device to access at least one micro-application of the first set of micro-applications from a second server via a second URL; and
serving the first scripting code to the first client device, wherein the first scripting code, when executed on the first client device, causes the first client device to assemble a first instance of the dynamic point-of-sale system user interface including the first set of micro-applications, and wherein the first client device is configured to render and display the first instance of the dynamic point-of-sale system user interface to a display of the first client device.

9. The non-transitory computer-readable device of claim 8, the operations further comprising:
receiving, from a second client device accessing the first server via the first URL, a login confirmation for a second user account;
determining a second user access control comprising at least one user role or user permissions associated with the second user account, wherein the second user access control is different from the first user access control;
selecting a second set of micro-applications permitted for the second user account based on the second user access control, the second set of micro-applications selected from the plurality of micro-applications, wherein the second set of micro-applications is different from the first set of micro-applications;
determining second scripting code configured to command the second client device to access at least one micro-application of the second set of micro-applications from the second server or a third server via a third URL; and
serving the second scripting code to the second client device, wherein the second scripting code, when executed on the second client device, causes the second client device to assemble a second instance of the dynamic point-of-sale system user interface including the second set of micro-applications, and wherein the second client device is configured to render and display the second instance of the dynamic point-of-sale system user interface to a display of the second client device.

10. The non-transitory computer-readable device of claim 9, wherein the first set of micro-applications comprises an inventory price management micro-application that enables updating or inserting pricing data for retail product records, and the second set of micro-applications comprises a customer verification micro-application that enables inputting or uploading customer verification information and documents.

11. The non-transitory computer-readable device of claim 9, the operations further comprising:
receiving, by the first server, from a third client device accessing the first server via the first URL, a login confirmation for a third user account;
determining a third user access control comprising at least one user role or user permissions associated with the third user account, wherein the third user access control is different from the first user access control and different from the second user access control;
selecting a third set of micro-applications permitted for the third user account based on the third user access control, the third set of micro-applications selected from the plurality of micro-applications, wherein the third set of micro-applications is different from the first set of micro-applications and the second set of micro-applications;
determining third scripting code configured to command the third client device to access at least one micro-application of the third set of micro-applications from the second server, the third server, or a fourth server via a fourth URL; and
serving, from the first server, the third scripting code to the third client device, wherein the third scripting code, when executed on the third client device, causes the third client device to assemble a third instance of the dynamic point-of-sale system user interface including the third set of micro-applications, and wherein the third client device is configured to render and display the third instance of the dynamic point-of-sale system user interface to a display of the third client device.

12. The non-transitory computer-readable device of claim 11, wherein the first user account is a retailer user account, the second user account is a customer user account, and the third user account is an administrator user account.

13. The non-transitory computer-readable device of claim 9, wherein the first instance of the dynamic point-of-sale system user interface comprises a first dashboard showing first inventory and pricing data, the second instance of the dynamic point-of-sale system user interface comprises a second dashboard showing second inventory and pricing data, and wherein the operations further comprise:
receiving, by the first client device and the second client device, messages in an event stream, thereby maintaining consistency between the first inventory and pricing data shown on the first dashboard and the second inventory and pricing data shown on the second dashboard.

14. The non-transitory computer-readable device of claim 8, wherein:
the first set of micro-applications comprises a parent micro-application, a first child micro-application, and a second child micro-application;
the first child micro-application and the second child micro-application each communicate with the parent micro-application; and
the first child micro-application and the second child micro-application are each configured to communicate with each other via the parent micro-application.

15. A system for building instances of a dynamic point-of-sale system user interface for enabling management of product leasing information on different client devices, the system comprising:
at least one processor of a first server; and
a memory storing instructions, which, when executed by the at least one processor, configure the processor to perform operations comprising:
receiving, from a first client device accessing the first server via a first uniform resource locator (URL), a login confirmation for a first user account;
determining a first user access control comprising at least one user role or user permissions associated with the first user account;
selecting a first set of micro-applications permitted for the first user account based on the first user access control, the first set of micro-applications selected from a plurality of micro-applications each having a product leasing information management feature including at least one of customer verification or inventory price management;
determining first scripting code configured to command the first client device to access at least one micro-application of the first set of micro-applications from a second server via a second URL; and
serving the first scripting code to the first client device, wherein the first scripting code, when executed on the first client device, causes the first client device to assemble a first instance of the dynamic point-of-sale system user interface including the first set of micro-applications, and wherein the first client device is configured to render and display the first instance of the dynamic point-of-sale system user interface to a display of the first client device.

16. The system of claim 15, the operations further comprising:
receiving, from a second client device accessing the first server via the first URL, a login confirmation for a second user account;
determining a second user access control comprising at least one user role or user permissions associated with the second user account, wherein the second user access control is different from the first user access control;
selecting a second set of micro-applications permitted for the second user account based on the second user access control, the second set of micro-applications selected from the plurality of micro-applications, wherein the second set of micro-applications is different from the first set of micro-applications;
determining second scripting code configured to command the second client device to access the second set of micro-applications from the second server or a third server via a third URL; and
serving the second scripting code to the second client device, wherein the second scripting code, when executed on the second client device, causes the second client device to assemble a second instance of the dynamic point-of-sale system user interface including the second set of micro-applications, and wherein the second client device is configured to render and display the second instance of the dynamic point-of-sale system user interface to a display of the second client device.

17. The system of claim 16, wherein the first set of micro-application comprises an inventory price management micro-application that enables updating or inserting pricing data for retail product records, and the second at least one micro-application comprises a customer verification micro-application that enables inputting or uploading customer verification information and documents.

18. The system of claim 16, the operations further comprising:
receiving, by the first server, from a third client device accessing the first server via the first URL, a login confirmation for a third user account;
determining a third user access control comprising at least one user role or user permissions associated with the third user account, wherein the third user access control is different from the first user access control and different from the second user access control;
selecting a third set of micro-applications permitted for the third user account based on the third user access control, the third set of micro-applications selected from the plurality of micro-applications, wherein the third set of micro-applications is different from the first set of micro-applications and the second set of micro-applications;
determining third scripting code configured to command the third client device to access at least one micro-application of the third set of micro-applications via a fourth URL from the second server, the third server, or a fourth server; and
serving, from the first server, the third scripting code to the third client device, wherein the third scripting code, when executed on the third client device, causes the third client device to assemble a third instance of the dynamic point-of-sale system user interface including the third set of micro-applications, and wherein the third client device is configured to render and display the third instance of the dynamic point-of-sale system user interface to a display of the third client device.

19. The system of claim 16, wherein the first instance of the dynamic point-of-sale system user interface comprises a first dashboard showing first inventory and pricing data, the second instance of the dynamic point-of-sale system user interface comprises a second dashboard showing second inventory and pricing data, and wherein the operations further comprise:
receiving, by the first client device and the second client device, messages in an event stream, thereby maintaining consistency between the first inventory and pricing data shown on the first dashboard and the second inventory and pricing data shown on the second dashboard.

20. The system of claim 15, wherein:
the first at least one micro-application comprises a parent micro-application, a first child micro-application, and a second child micro-application;
the first child micro-application and the second child micro-application are each configured to communicate with the parent micro-application; and
the first child micro-application and the second child micro-application are configured to communicate with each other via the parent micro-application.
.
